(19) United States
(12) Patent Application Publication
(10) Pub. No.: US 2018/0260841 A1
(43) Pub. Date: Sep. 13, 2018

(54) BEST-RESULT-FOR-DEMANDER DEVELOPMENT APPLICATION, SUPPLIER/PROVIDER MARKET AND DEMAND MATCHING AND RELATIONSHIP MANAGEMENT SYSTEM

(71) Applicant: Manminder Kandola, Oakville (CA)

(72) Inventor: Manminder Kandola, Oakville (CA)

(21) Appl. No.: 15/665,052

(22) Filed: Jul. 31, 2017

Related U.S. Application Data
(60) Provisional application No. 62/469,606, filed on Mar. 10, 2017.

(51) Int. Cl. G06Q 30/02; G06Q 50/00

(52) U.S. Cl. CPC G06Q 30/0251; G06Q 50/01

(57) ABSTRACT

A system for implementing an open competition of a Demander's set of requirements for products/services, and matching and nurturing relationships between users of the system. Demanders define their specific business opportunity and the system matches that business opportunity to the provider/suppliers configured target market. Those matched providers submit their better-offer-than-last in their home tier, where all offers are seen by all provider/suppliers and Demanders with contact identify information masked and only selective performance based information shown. Personal and contact information of the subject demander is shared to the system-determined winning providers/suppliers, with different levels of access depending on the best-result-for-demander determination by the system, and disclosing the selective provider/supplier personal and contact info with the subject demander. The system additionally presents relationship management modules and the opportunity to establish a preferred network between the demanders and the providers/suppliers at multiple points of the relationship nurturing process.

### CROSS-REFERENCE TO RELATED APPLICATION

This application claims priority to U.S. Provisional Patent Application No. 62/469,606, filed Mar. 10, 2017, entitled “BEST-RESULT-FOR-CONSUMER DEVELOPMENT APPLICATION AND SUPPLIER/PROVIDER MATCHING SYSTEM AND METHOD,” which is incorporated herein by reference in its entirety.

### BACKGROUND

The present disclosure is directed to an internet connected computer system and method that provides demanders an interface to identify their needs and requirements for products and services, and have the system develop best-current-offerings and matches from single or multiple providers, by categorizing, organizing and structuring the demand advertising where selective and timed information is displayed to matching and competing providers/suppliers of that demand, and the system provides a platform for accepting and re-accepting offer submissions utilizing features such as open competition framework, social media integration and supportive market data filtering, categorizing, converting and presentation. Throughout, the system provides relationship development and management modules to enhance security, matching and accountability amongst all parties, evolve the market and business relationship and help both demanders and providers/suppliers to maintain, enhance and expand techniques, products and services.

### SUMMARY

In one embodiment of the present disclosure, the system will match the demanders need advertising with demander/supplier/provider preferences, settings and profiles, delivering the demander/supplier/provider access to their desired relationships and target markets. In another embodiment of the present disclosure, the system will provide the supplier/provider the opportunity to submit and resubmit offers and provide demanders/suppliers/providers features to give feedback and knowledge on their market position, and present a direct opportunity for the demanders/suppliers/providers to be matched and/or win the demanders business efficiently and effectively. In another embodiment of the present disclosure, the system will deliver best-current-offering(s) from multiple types of supplier/providers that matches the needs of the Demander, and organized to present multiple potential acquisition channels and/or versions of the product or service being requested by the Demander.

In another embodiment of the present disclosure, the system will provide a platform that can be used to manage, normalize, nurture and enhance the relationship between demander and supplier/provider.

### BRIEF DESCRIPTION OF THE DRAWINGS

The components in the drawings are not necessarily to scale relative to each other. Like reference numbers designate corresponding parts throughout the several views.

FIG. 1 illustrates an example core process flowchart;

FIGS. 2A-2C illustrate an example technical entity relationship diagram;

FIG. 3 illustrates an example system functional architecture diagram;

FIG. 4 illustrates example core Model structures;

FIG. 5 illustrates example core Controller structures;

FIG. 6 illustrates example View structures;

FIG. 7 illustrates example run-time API's libraries that are installed and implemented in the system of the present disclosure;

FIGS. 8A-8E illustrate example system signup pages;

FIGS. 9A-9B illustrate example profile views;

FIG. 10A-10B illustrate example financial products and services opportunity creation interfaces;

FIG. 11 illustrates an example of how a provider configures their target markets to serve each product and service;

FIG. 12 illustrates an example of the provider/supplier dashboard and the presentation of the opportunity as a call-to-action for the provider/supplier to submit an offer;

FIGS. 13A-13B illustrate example of how a compilation of selected Demander profile data and opportunity information is presented to allow the provider supplier to apply rational decision making, adjudicate and assess the risk associated in servicing the Demander defined opportunity;

FIG. 14 illustrates an example Demander view of the open competition process;

FIG. 15 illustrates an example interface associated with bi-directional ratings and value management data collected;

FIG. 16 illustrates example views provide to marketplace administrators; and

FIG. 17 illustrates example public layers of the system.

### DETAIL DESCRIPTION

### Overview

Many industries are facing issues of rising costs, high failure rates and marginal rates of return with traditional sales methods. Ineffective marketing and inefficient positioning in business development opportunities cause demanders to delay decisions due to the pace and quality of gaining confidence in the specific provider/supplier during the sales cycle. As used herein, a “demander” is a requester of products/service. The phenomenon finds the demanders behavior struggling to understanding and evaluate the fit to meet their needs and requirements due to the complexity and variability of product/service offerings presented to them.

Using sales and marketing strategies that adopt all-encompassing consideration of a demanders needs can result in highly effective and efficient sales cycles that can contribute significantly to the optimization of margins and can yield high returns. The embodiments of the system disclosure allow providers and/or suppliers to adopt a demand-centric approach to marketing and selling through a digital tool and channel that transforms the way demanders shop for products/services. The embodiments of the system provide the ability for demanders to empower themselves by controlling the definition and declaration of business opportunity for provider/suppliers to participate in, and having the system formulate and execute the research and evaluation process required to assemble qualified product/service offerings that are entirely centered and directly matched to the Demanders' needs and requirements.

With this system, an online marketplace is created where demanders/providers/suppliers can do business effectively and efficiently by capitalizing on their knowledge of market positions and reducing the risk related to the daily sales and transactions of business. This system will provide a platform that will allow suppliers/providers to only initiate their sales cycle for opportunities that match their target markets and present offerings with a selective transparent view to all the offerings available to the demander from different channels.

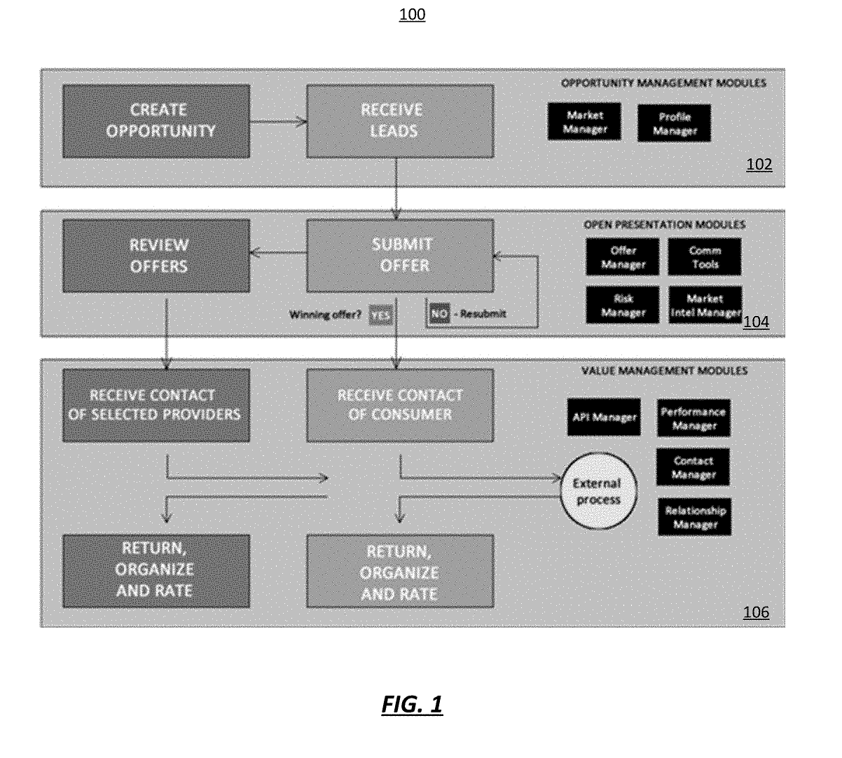

With reference to FIG. 1, there is illustrated an example core process flowchart 100. The flowchart 100 is a form of a logic diagram that illustrates the core process flow of the system. At 102, the Demander or demander identifies the needs and creates a well-defined opportunity, reducing product or service variables through system interfaces and/or data integrated. The system then matches that opportunity with the target market configuration and settings specified by providers and suppliers, and presents that opportunity to providers and suppliers with selected profile data attached.

At 104, the providers and suppliers review the opportunity the system presented, using system provided risk management tools and/or data as well as external processes and risk data analysis models, and submit offers through system interfaces for the Demander or demander to preview. This step can be iterative until the demander, provider or supplier is satisfied with their submitted offer for the business development opportunity presented, or the system configured logic can close the opportunity for additional offer submissions.

At 106, the system will use configured logic and factors to assess all the submitted offers and present the best-results-for-demander. The system will exchange additional information to both parties and connect the demanders and the providers or supplier. External processes can be utilized to initiate, append or complete the transaction and thereafter demanders and providers or suppliers are expected to return to the system to organize the business and provide data, ratings and feedback for each other.

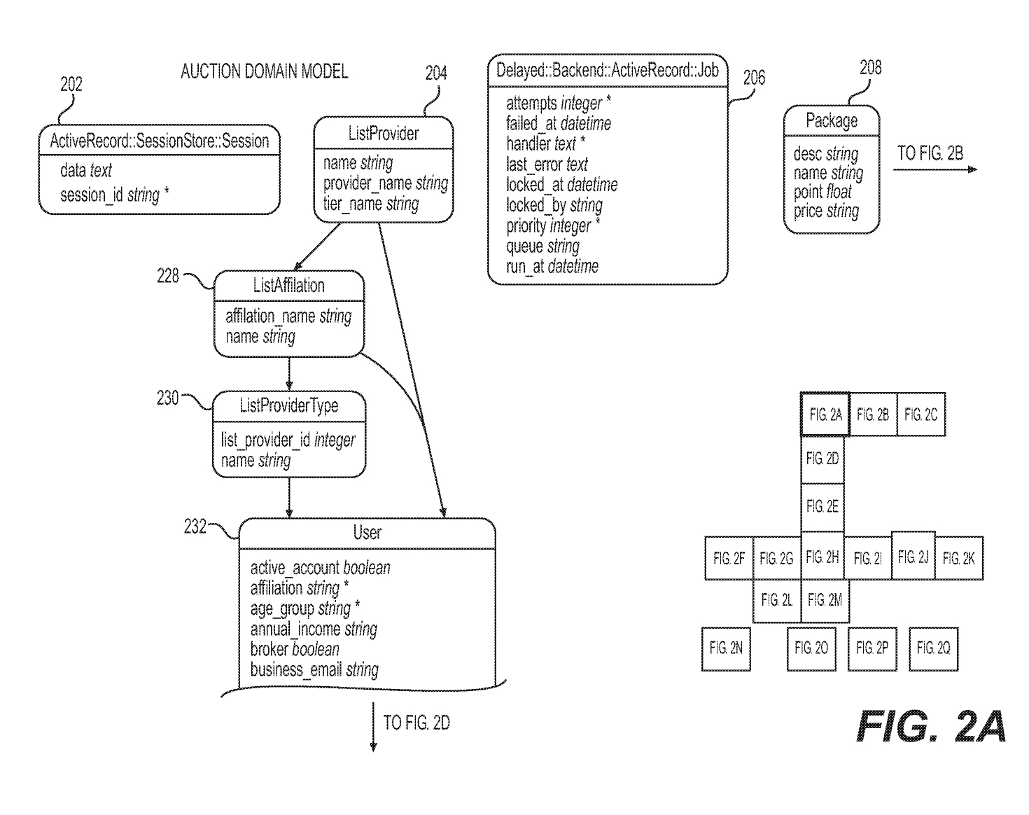

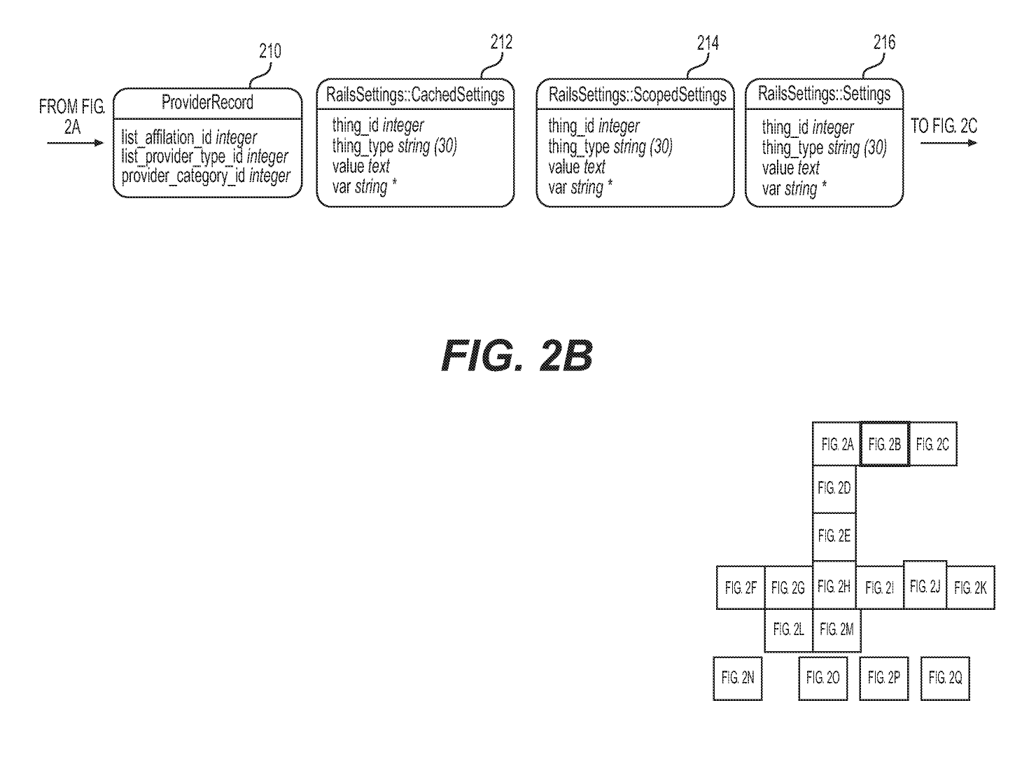

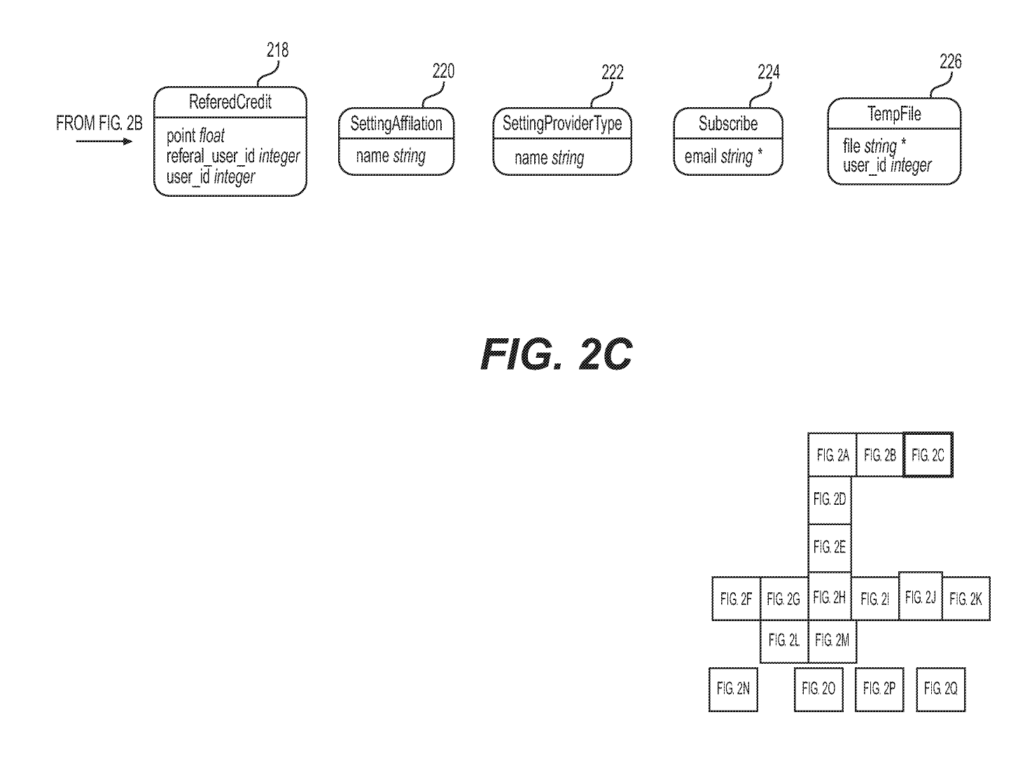

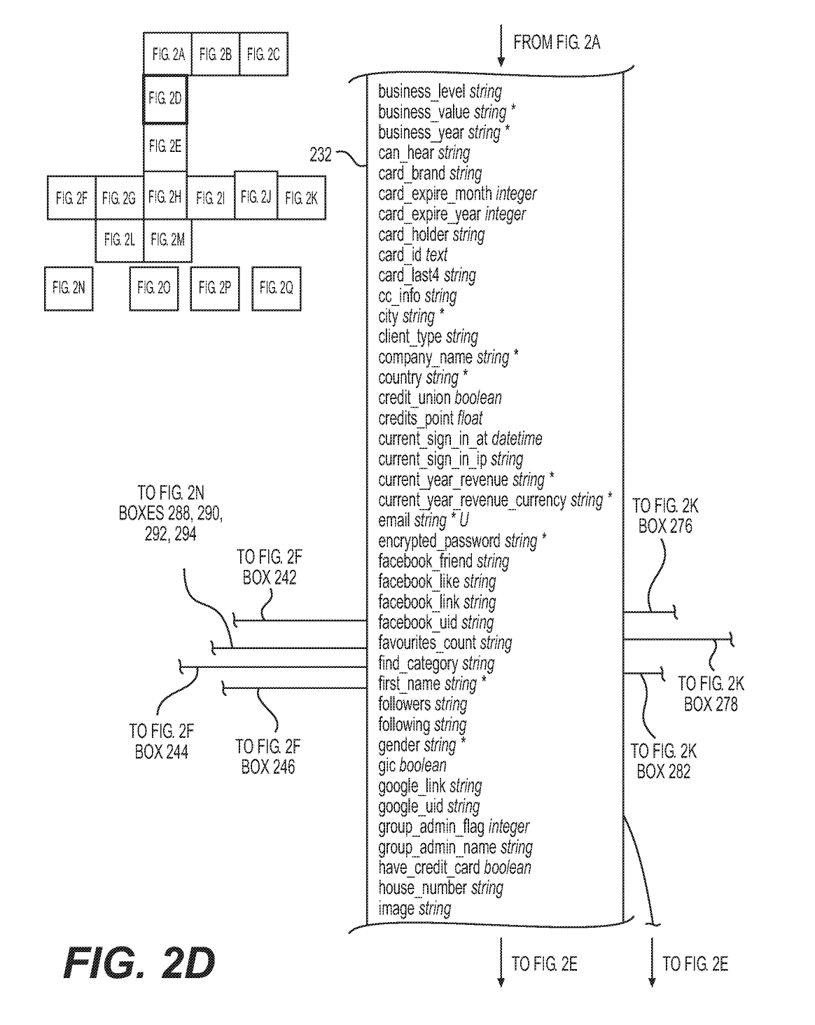

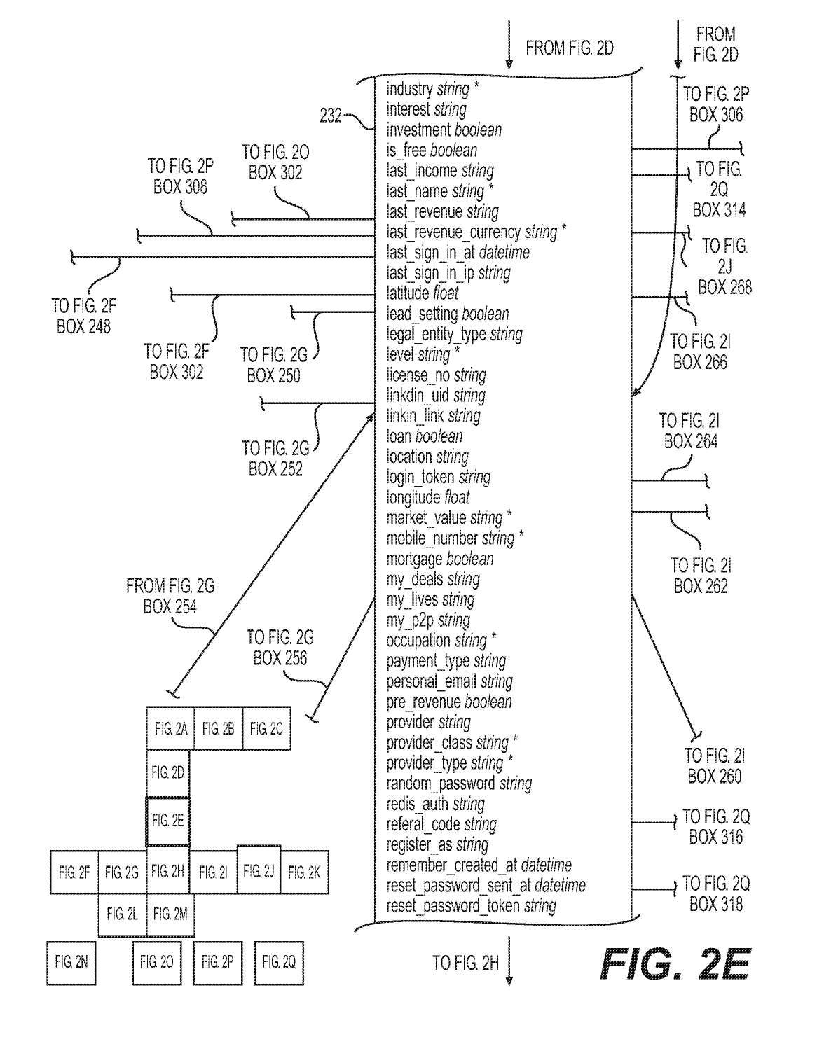

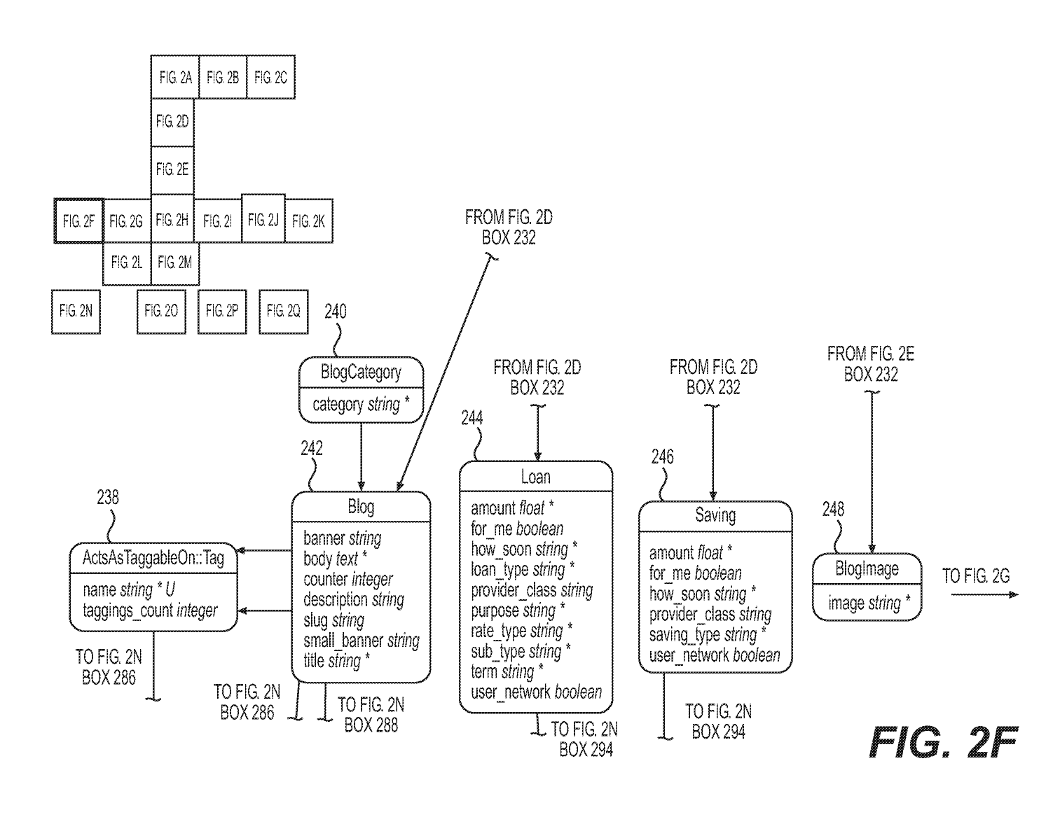

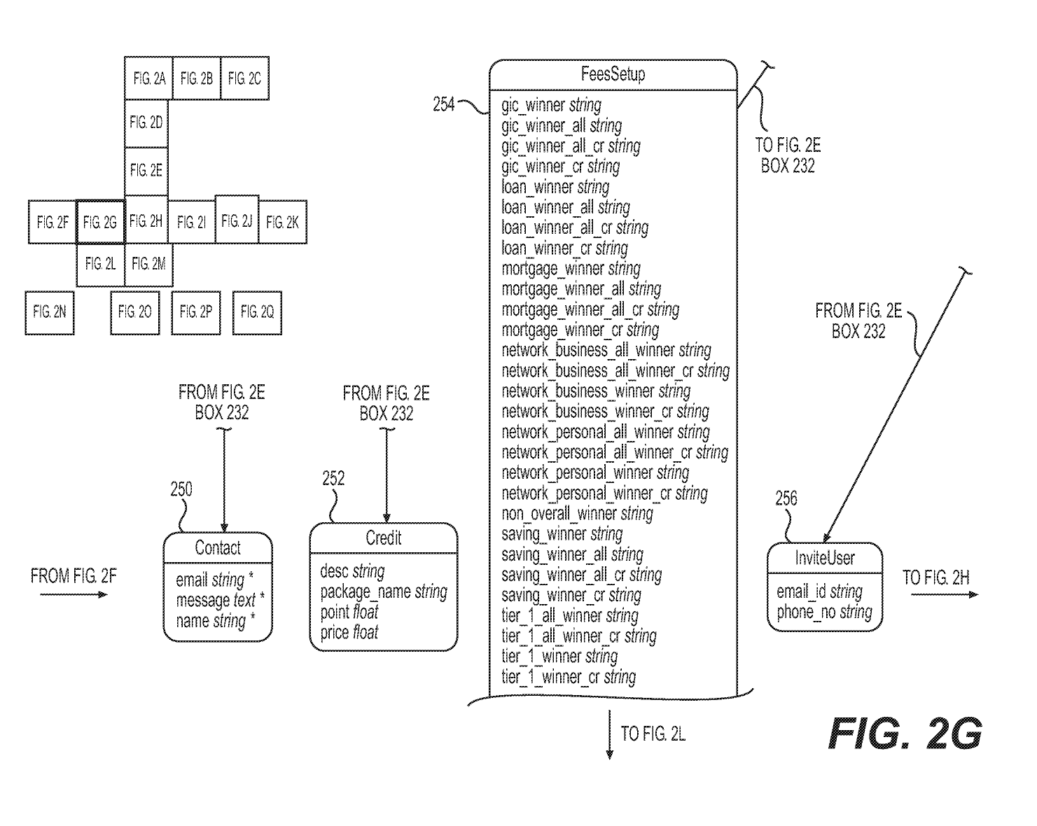

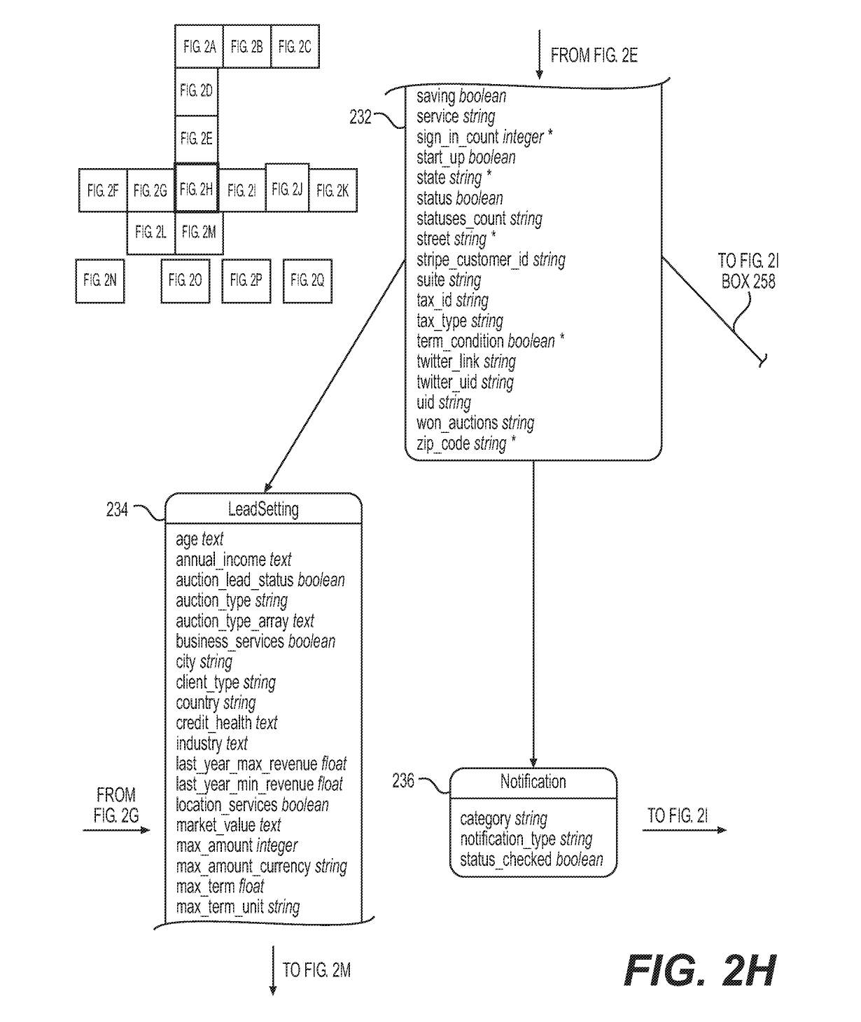

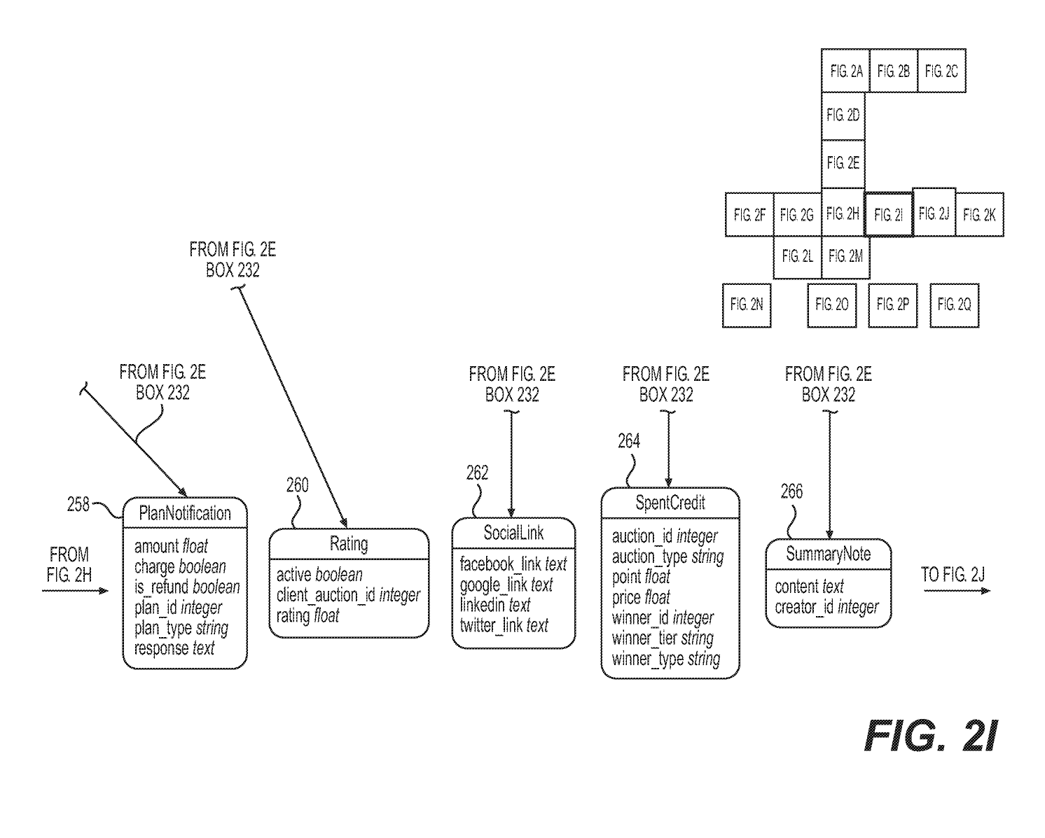

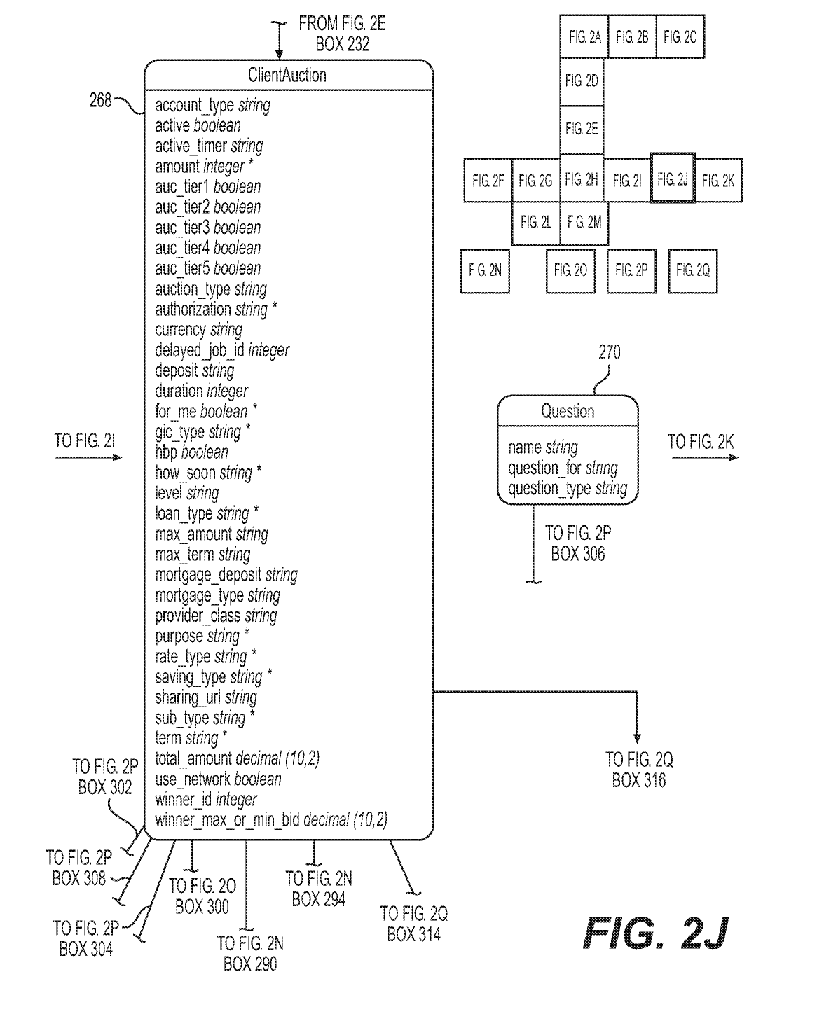

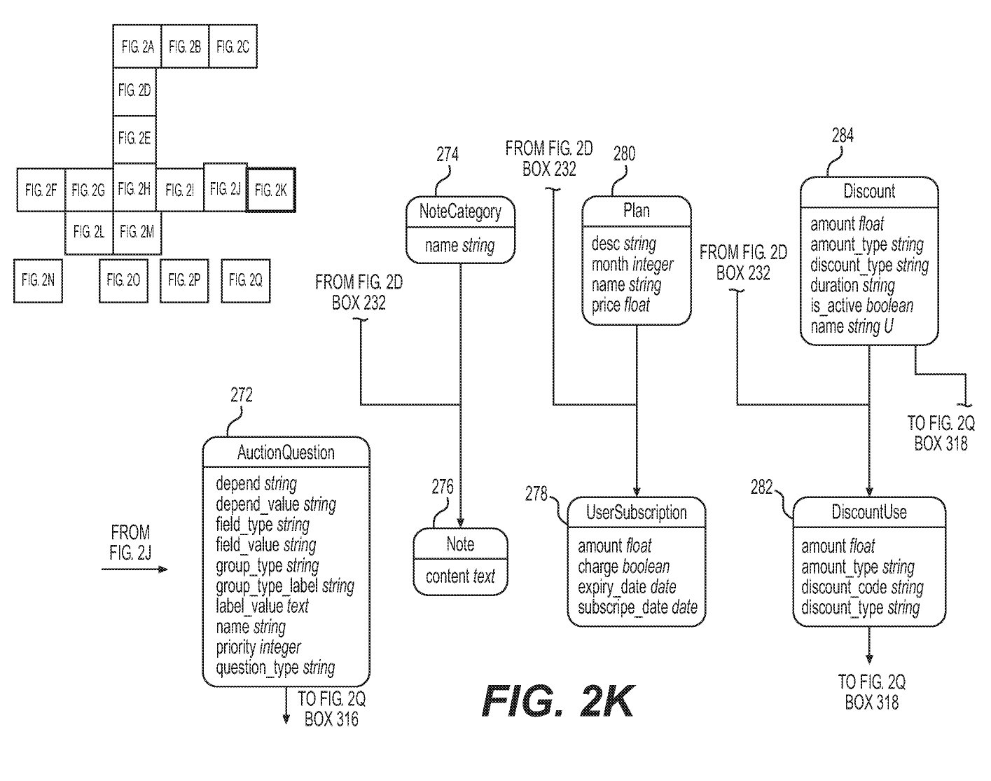

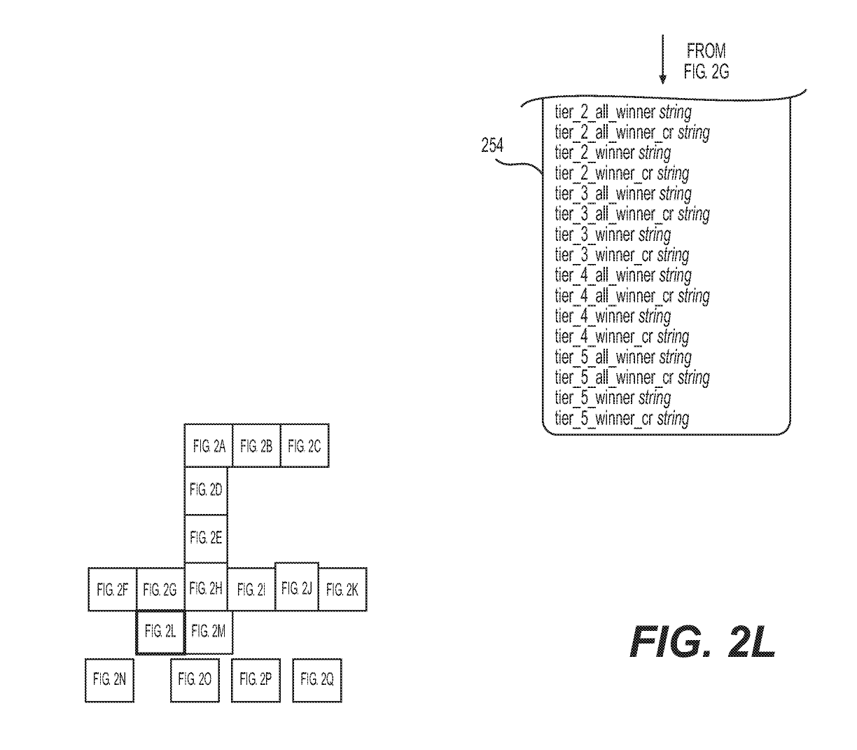

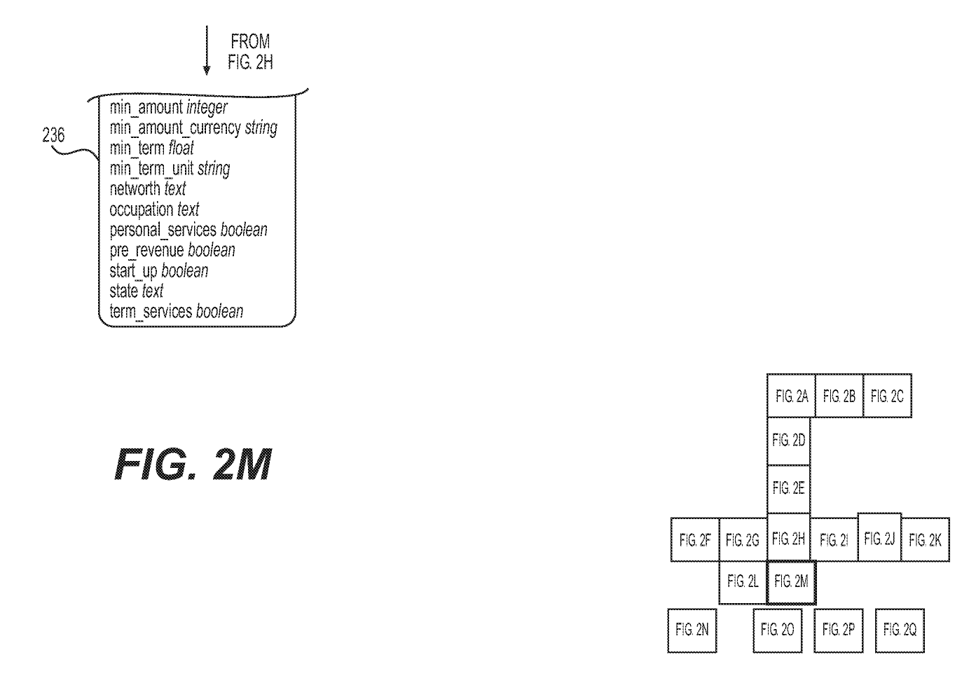

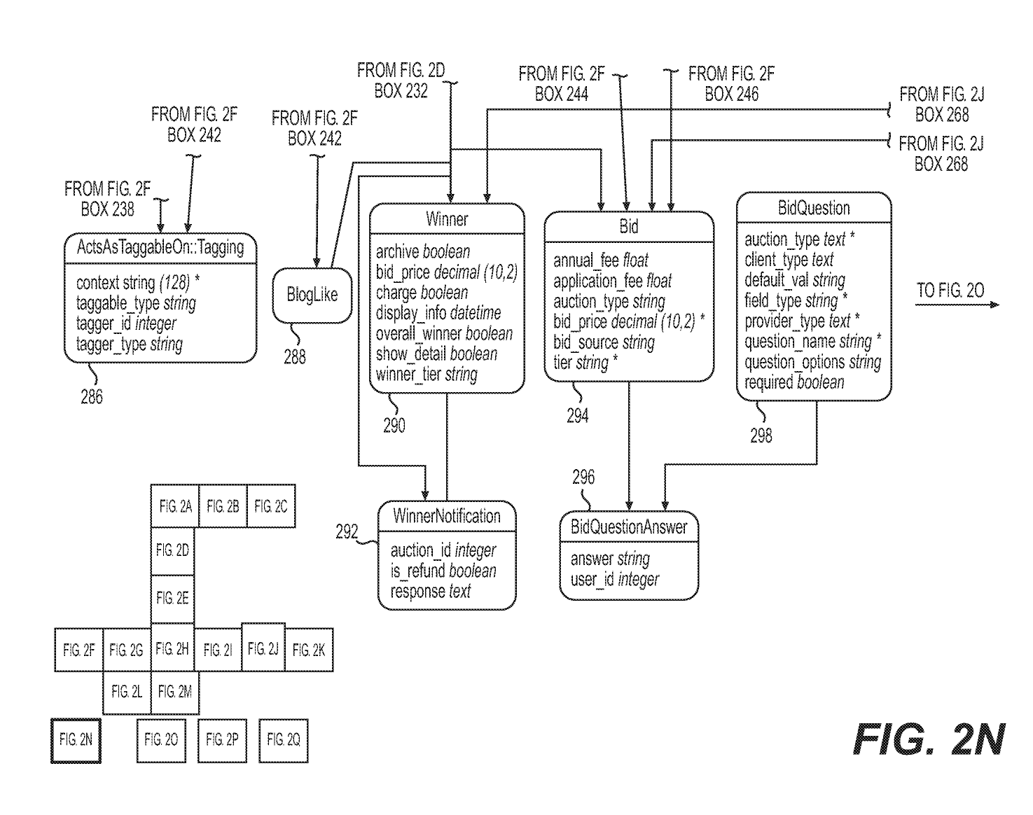

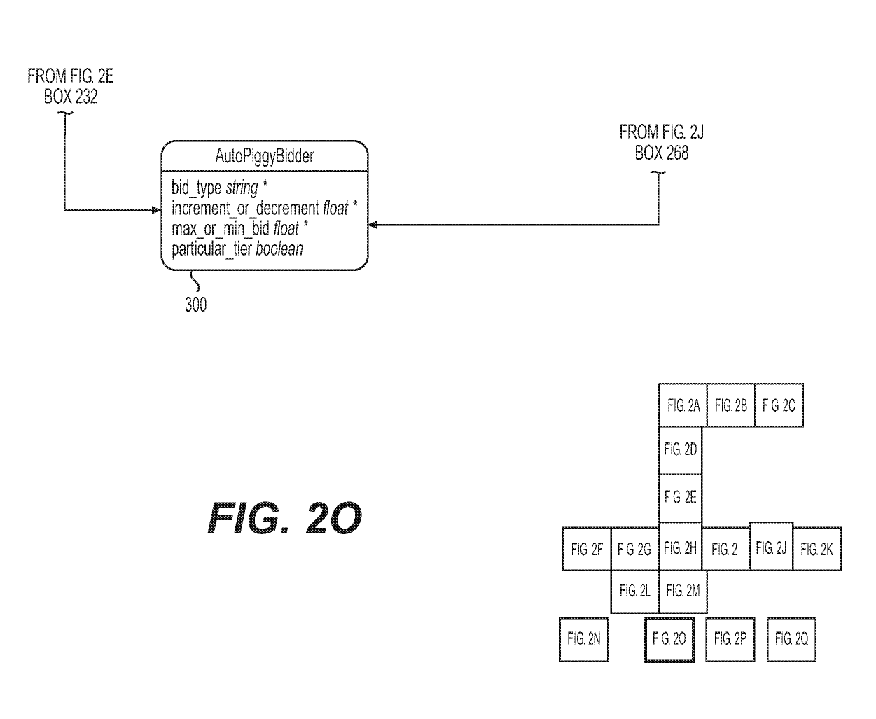

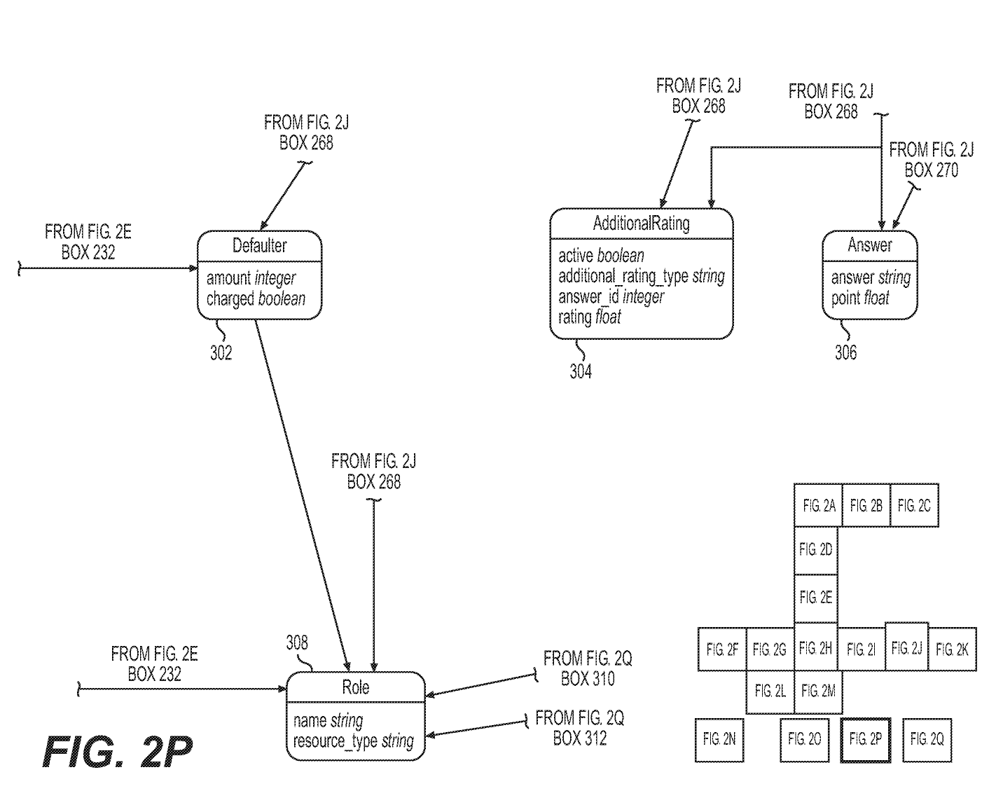

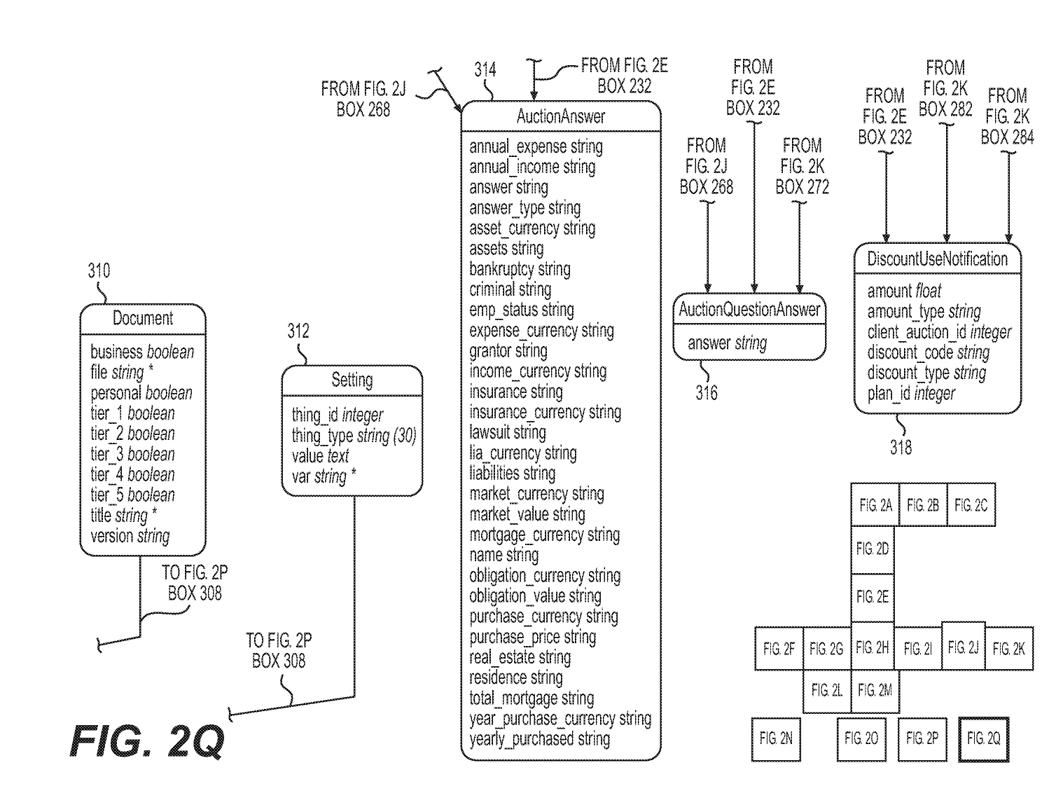

FIGS. 2A-2C illustrate an example technical entity relationship diagram. FIGS. 2A-2C are a form of a logical diagrams illustrating of the core models, relations and abstractions of entities in the technical architecture of the system. The system built using a computer programming language that supports a Model-View-Control application architecture. The USER entity is the center of the architecture and this creates a coherent framework that helps to achieve consistency in quality and in format for the systems application architectural definitions. The user object is connected through all the View, Controller and Model structures that support social media and third party integrations, payment processing and offer presenting modules etc.

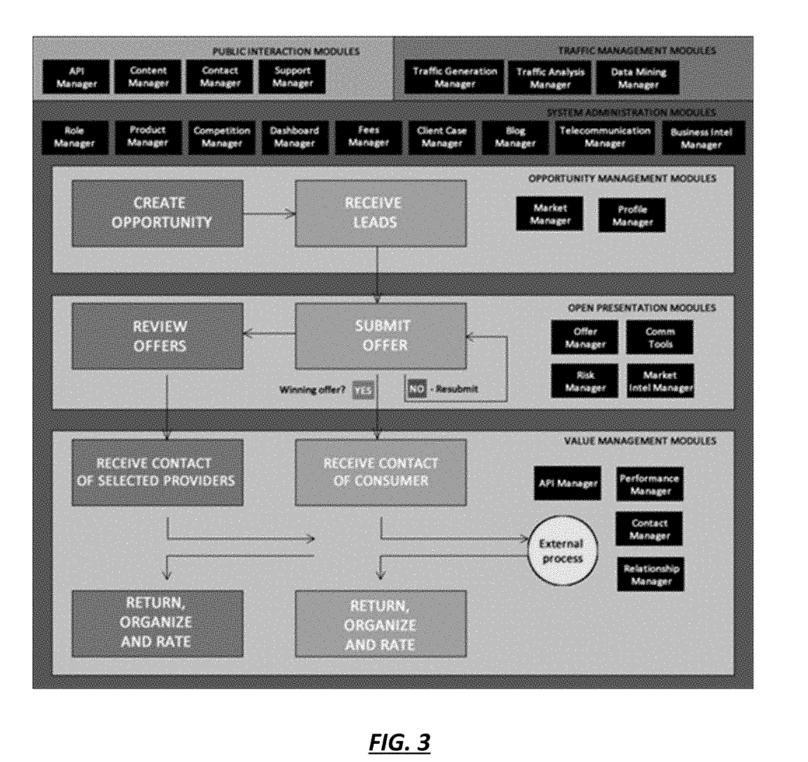

FIG. 3 illustrates an example system functional architecture diagram. The diagram below is a form of a functional diagram illustrating the scope and interconnection of the core modules in the system. This representation of the system provides a mapping of functionality to software components, and provides the fundamental organization of the system, embodied in its components, their relationships to each other and the environment and principles that govern the scaled design and evolution of the economic value the system provides. The functional architecture domains that support the core process tiers of the system are categorized under i) Public Integration, ii) Traffic Management and iii) System Administration. The System Administration functional domain defines the logic controls of the core process through a configuration of the platform that is required for the Opportunity Management, Open Presentation and Value Management modules to function.

Technology Architectural Design

The system platform of FIGS. 1-3 may be hosted on a cloud based infrastructure that leverages a virtual partition which draws its resources, such as disk space, power, on-board memory, from an extensive network of underlying physical servers that provide the system an infrastructure that features high degree of reliability, multiple methods of security and dynamic on-demand scalability. The system includes implementation of third party communications and notifications systems that leverage Email, Short Message Service (SMS), Multimedia Message Service (MMS) and external connections to other digital platforms and/or native mobile operating system integrations for a specific mobile device. The system web application architecture is based on a Model View Controller (MVC) software design pattern that divides the code of the application into separate but closely cooperative subsystem domains. The set of computed programs and code library used to code the system is based on the Ruby on Rails software framework.

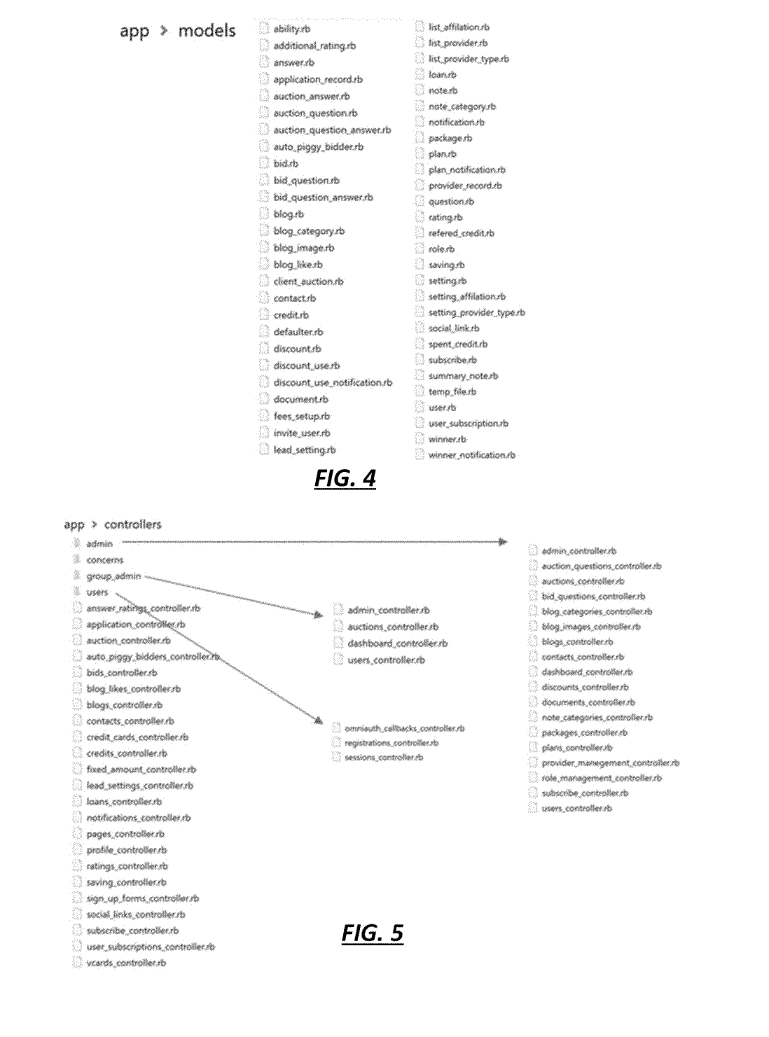

The Model in the applications domain is responsible for maintaining data and supports the entities and their relationships and models the database structure to store the entities and their relationships. The Model maintains the ActiveRecord object library in the application that binds the tables in the underlying relational database and the code that manipulates database records and handles validation, association, transactions and more. Ruby method names are automatically generated from the field names of database tables. The core Model structures that exist in the application are shown in FIG. 4.

The Controllers in the application domains are responsible for all the possible scenarios and actions that the elements and entities of the system application domain can interact with each other. The Controller directs traffic querying the models for specific data and organizing that data (searching, sorting, messaging it) into a form that fits the needs of the specified views. The Controller layer of the code implements the ActionController library which brokers the data sitting between the Model's ActiveRecord database interface and the View's ActionView presentation logic. The core Controller structures that exist in the application are show in FIG. 5.

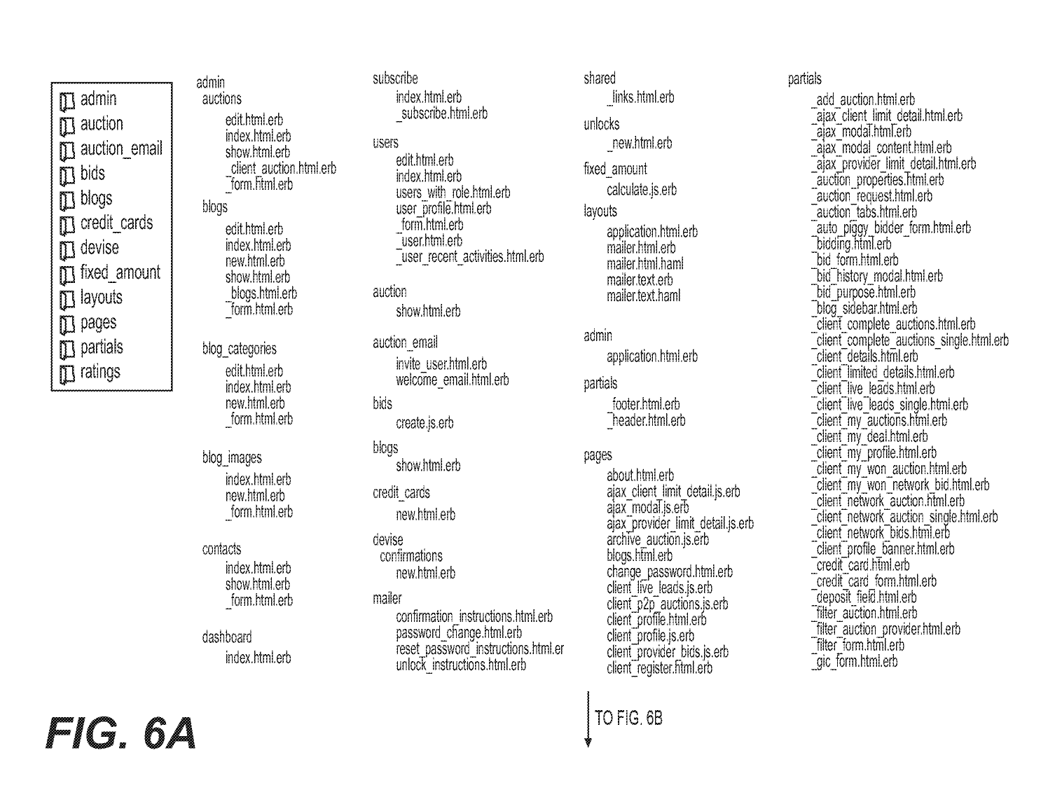

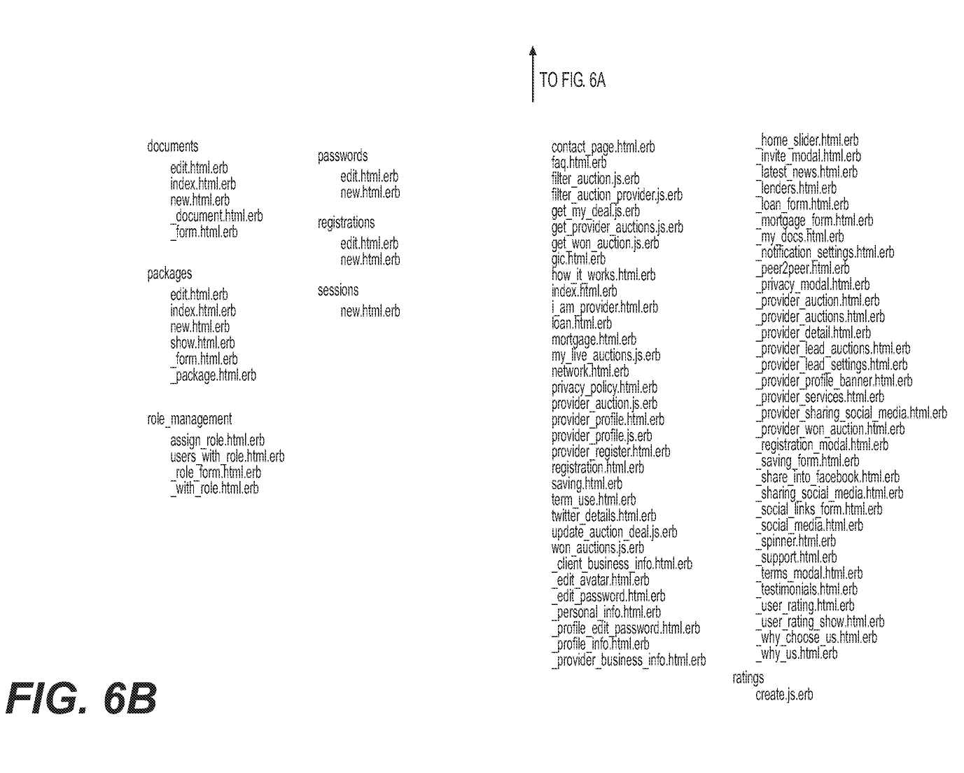

The Views in the application domain are responsible for all the presentation layer views of the data and shows the user the where data and processes stand at a certain point. The View layer is triggered by the Controller layer logic and provides the system a navigation interface for the user to functionalities and features of the system. The View layer in this system leverages script based template systems like Javascript, PHP, ASP, JSP and integrates with AJAX and Node.js technology. The View layer of the code implements the ActionView library, which is an Embedded Ruby (ERb) based system for defining presentation templates for data presentation. Every Web connection in this Rails based application results in the displaying of a view. The core (top level and first sub level) View structures that exist in the application shown in FIG. 6.

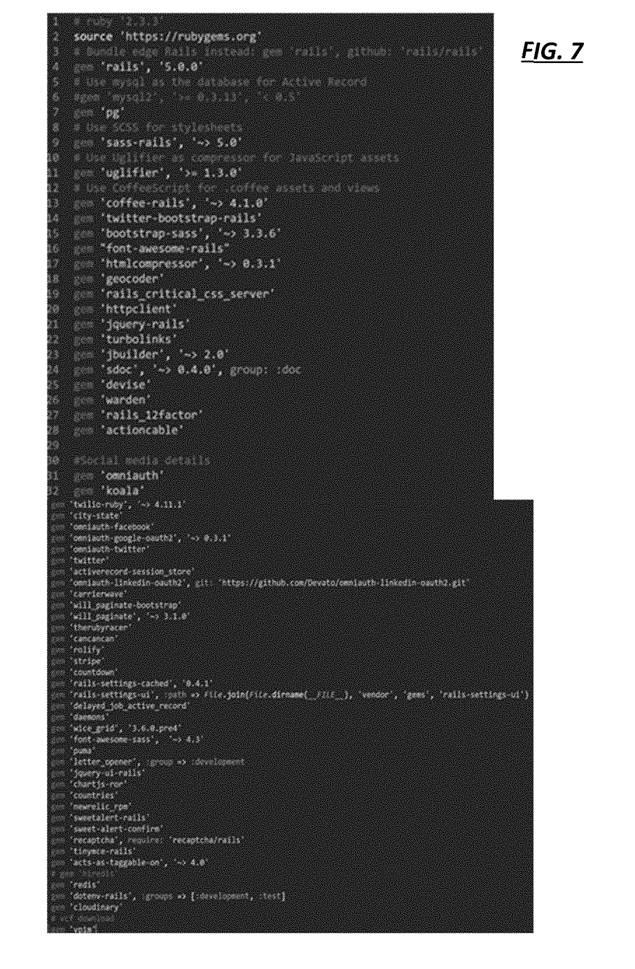

The systems application domain includes access to external code layers and functionality through the implementation of published Application Programming Interfaces (API) over secure encrypted networks to digitally execute payment processing, integrate social media data and information, and provide partial or full product/service commitment transaction integration to external provider systems. RubyGems are run-time API's libraries installed and implemented in the system and represent the integrated features and systems in the system, as shown in FIG. 7.

### Signup, Authentication and Authorizational Modules

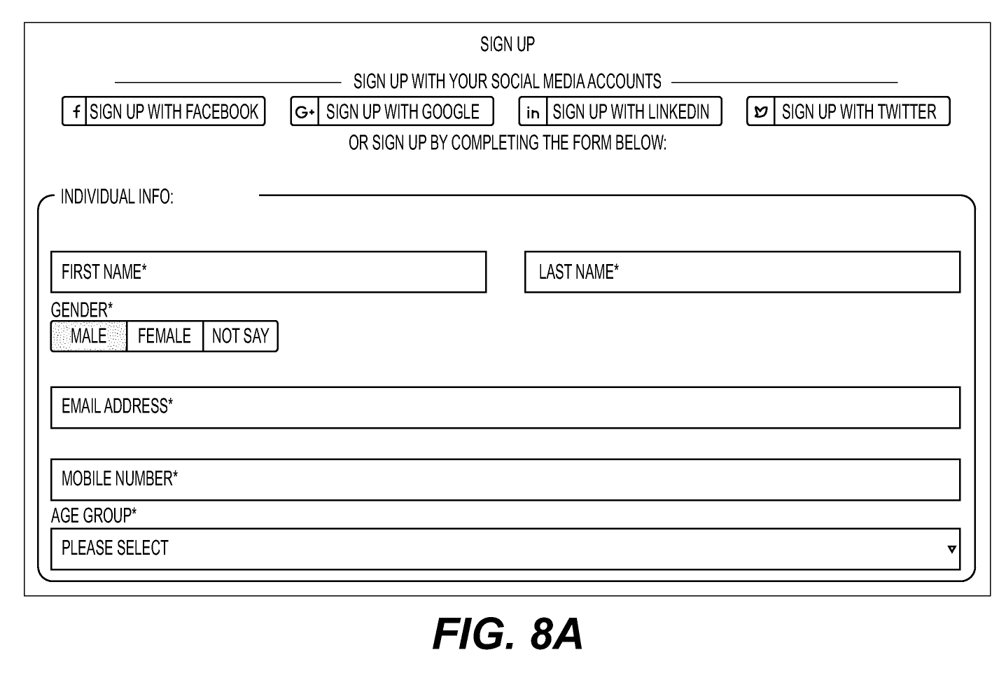

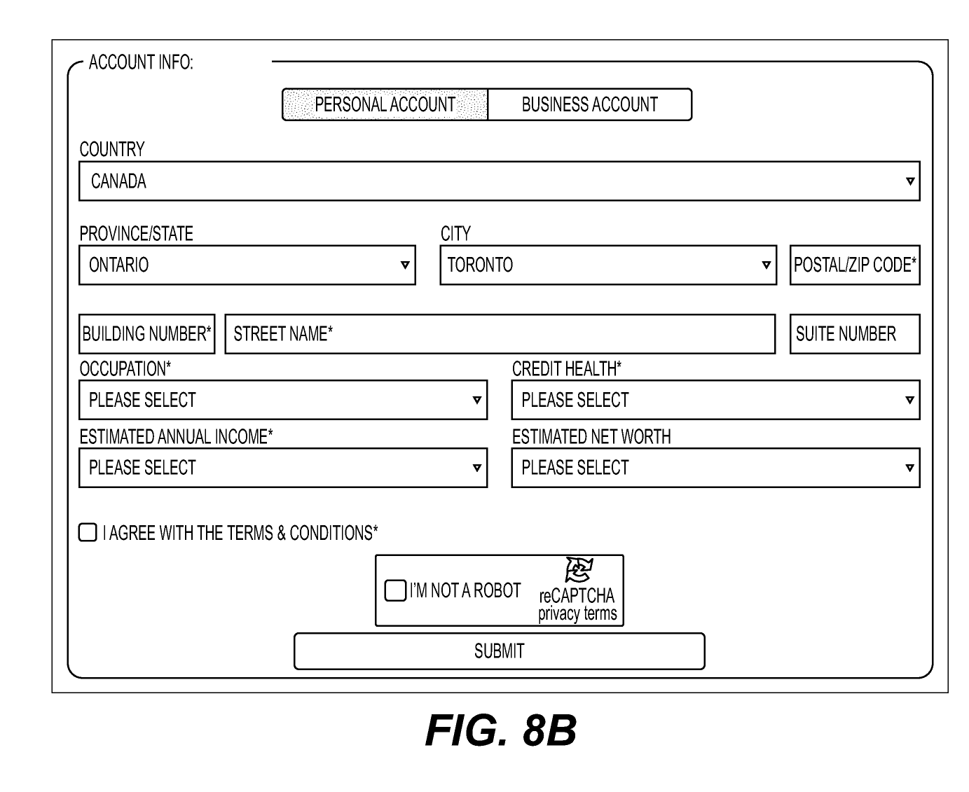

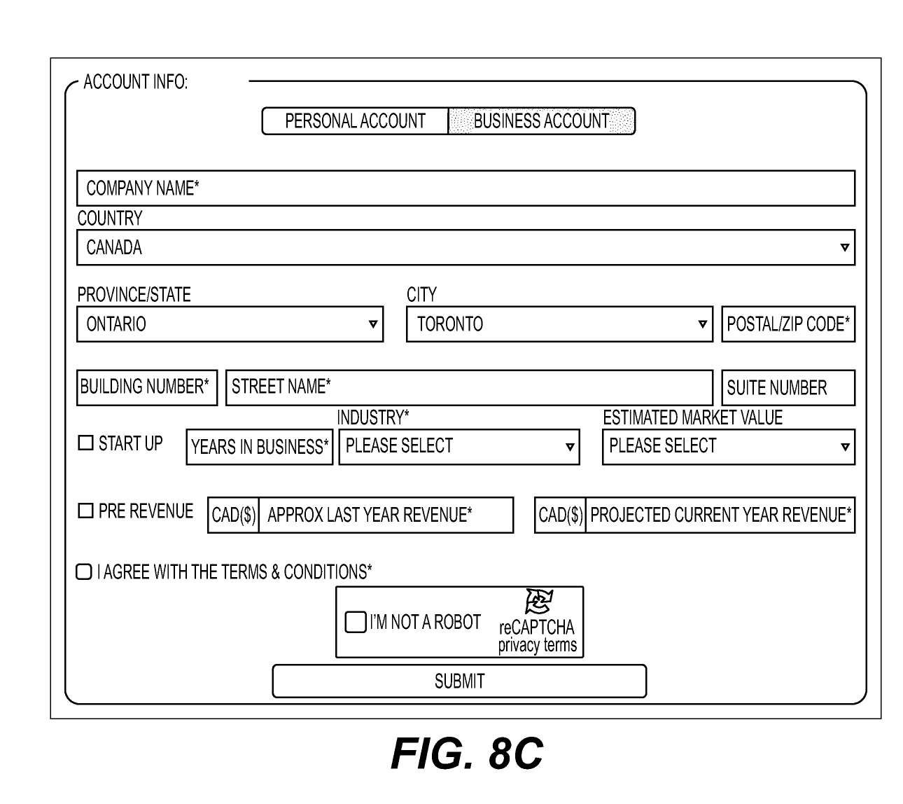

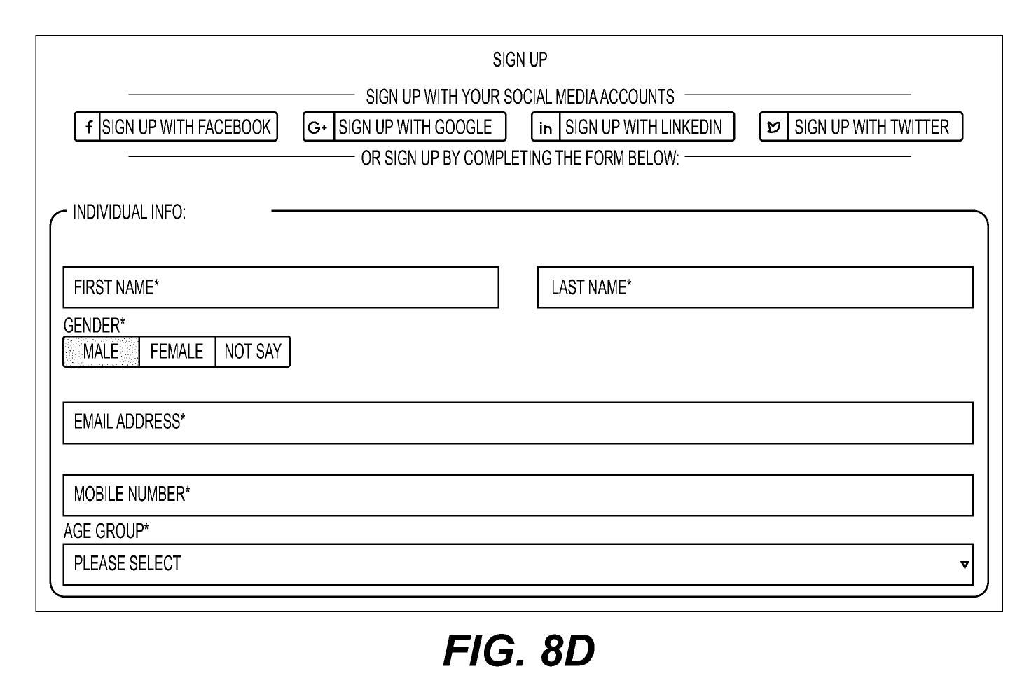

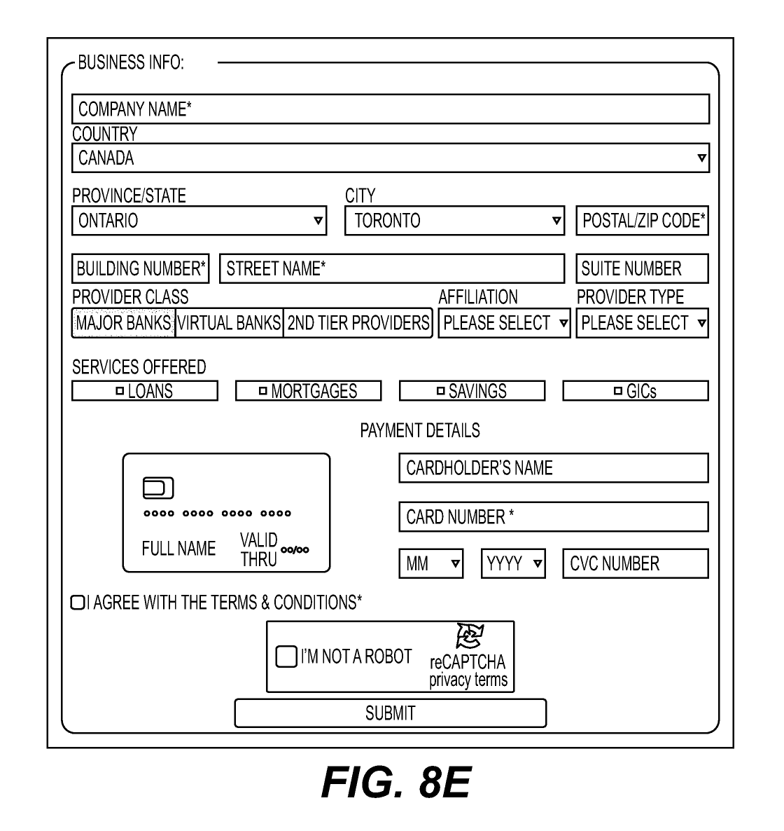

The system platform requires users to register, acknowledge, agree and comply with notifications, terms and conditions through the platform's signup interfaces. Signup interfaces are provided for Demanders to store contact and other information used to create a marketplace profile that identifies themselves as either as individuals or business entities, and similarly for Suppliers/Providers who identify themselves with their affiliations and supplier types. The Signup process also provides the interface to initially collect information that will be used to process fees and payments the platform will incur and charge. A sample of the system signup pages for Demander—individual or business—featuring integrating with social media platforms or other external authentication and verification systems, are illustrated in FIGS. 8A-8C.

A sample of the system signup pages for Supplier/Provider's businesses featuring integrating with social media platforms, other external payment, authentication and verification systems, are illustrated FIGS. 8D-8E.

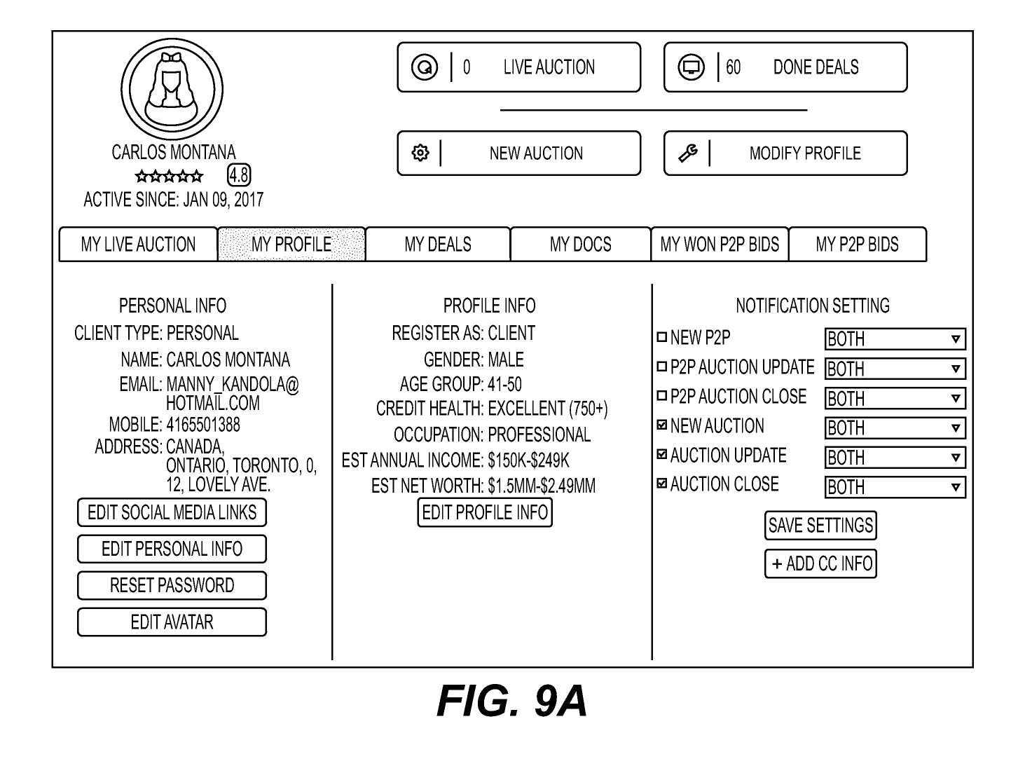

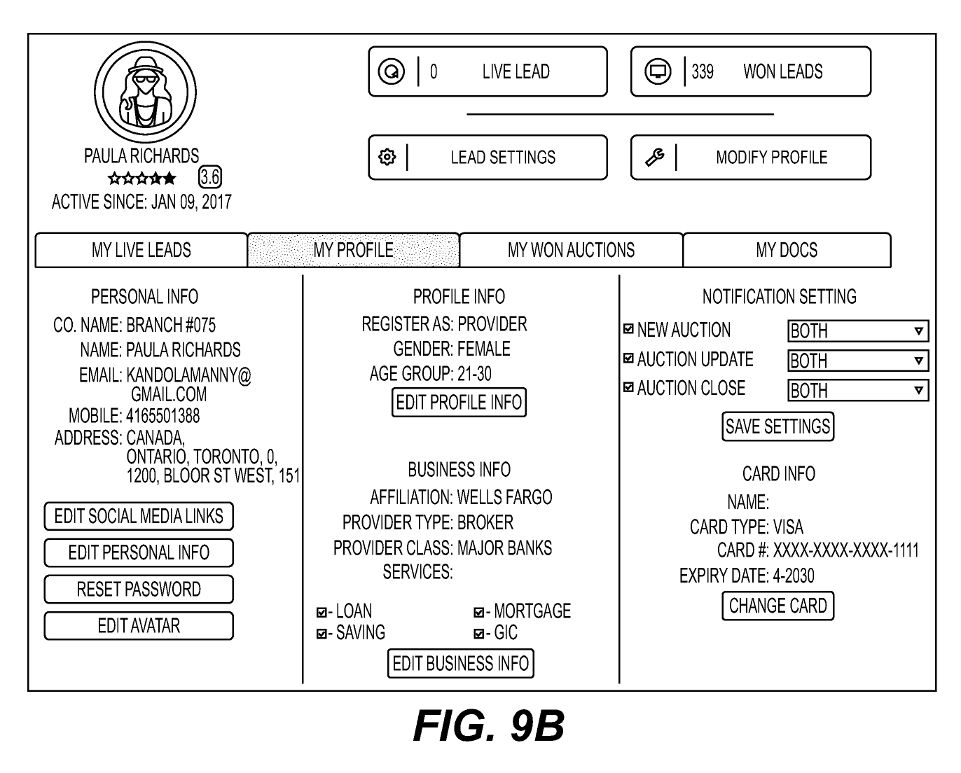

In addition the system provides the ability to manage profiles, and preferences related to those profiles, dynamically by each user within the system for each of the core Demander and provider/supplier profile types. Example profile views are shown in FIGS. 9A-9B and feature assignment of controls for communications methods available in the process, and avatars from a library of avatars provided by the system or uploaded or linked by the user from an external source.

A user's profile data is selectively and strategically processed, transformed and presented throughout the execution of the core process illustrated in FIG. 1, and across the core modules illustrated in FIG. 3, to support the core functional process of the system. This includes data available to public and preferred communities determined by the system and self-defined by users.

### Opportunity Management Modules

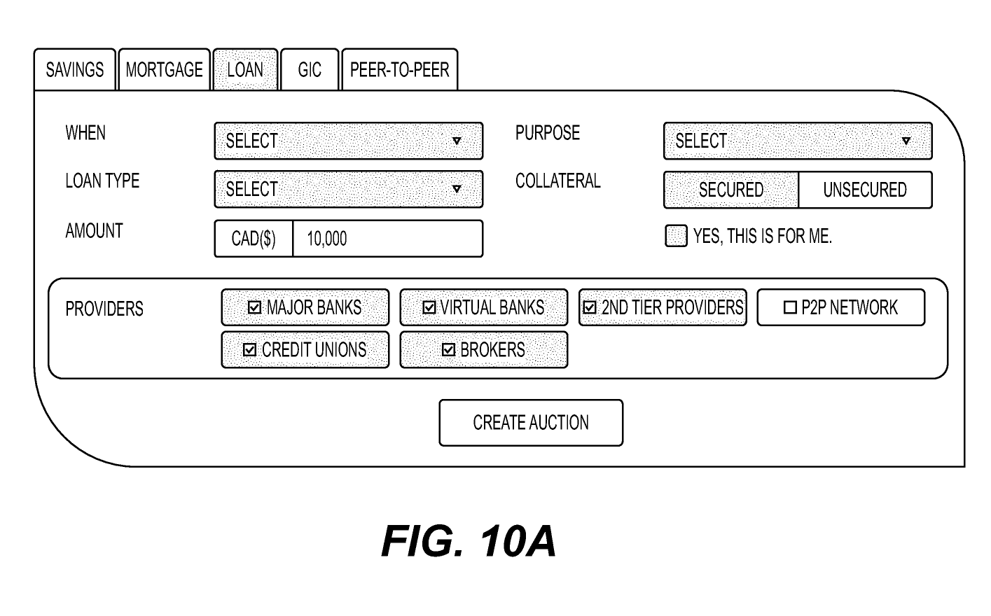

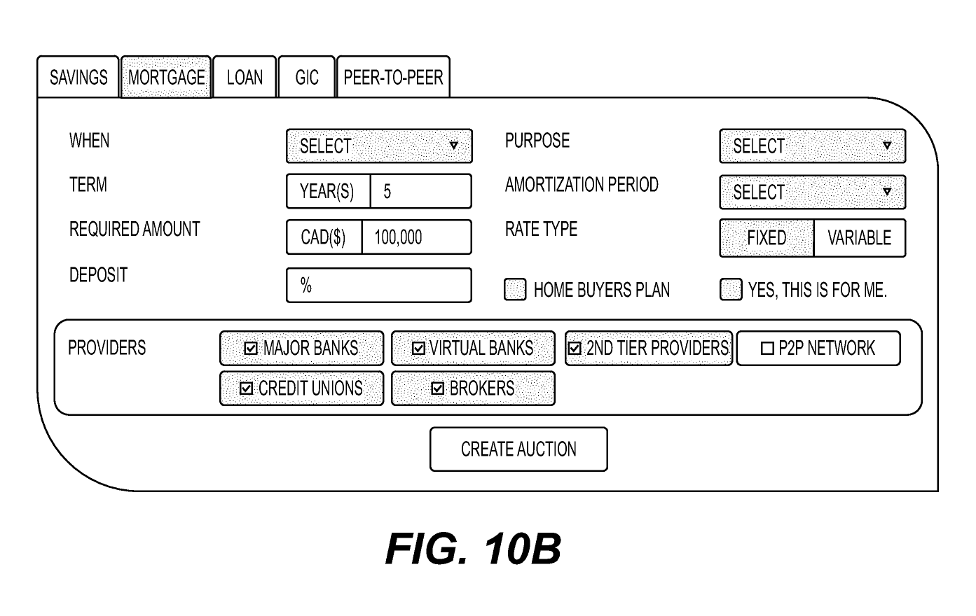

The Opportunity Management modules provide the functionality to manage the interface and the logic engine that constructs, matches and presents the Demander defined opportunity with the configuration of Provider/Supplier target markets defined in the system. As illustrated in FIG. 1, at 102, the Demander or buyer identifies the needs and creates a well-defined opportunity, reducing product or service variables through system interfaces and/or data integrated. Limiting the variables from a Demander's perspective that exist when selecting a financial product further streamlines the sales cycle and benefits both Demander and Provider/Supplier. The system then matches that opportunity with the target market configuration and settings specified by Providers/Suppliers, and presents that opportunity with system and demander configured profile data attached. A sample of how a configuration of the products and services opportunity creation interfaces are structured are shown in FIGS. 10A-10B.

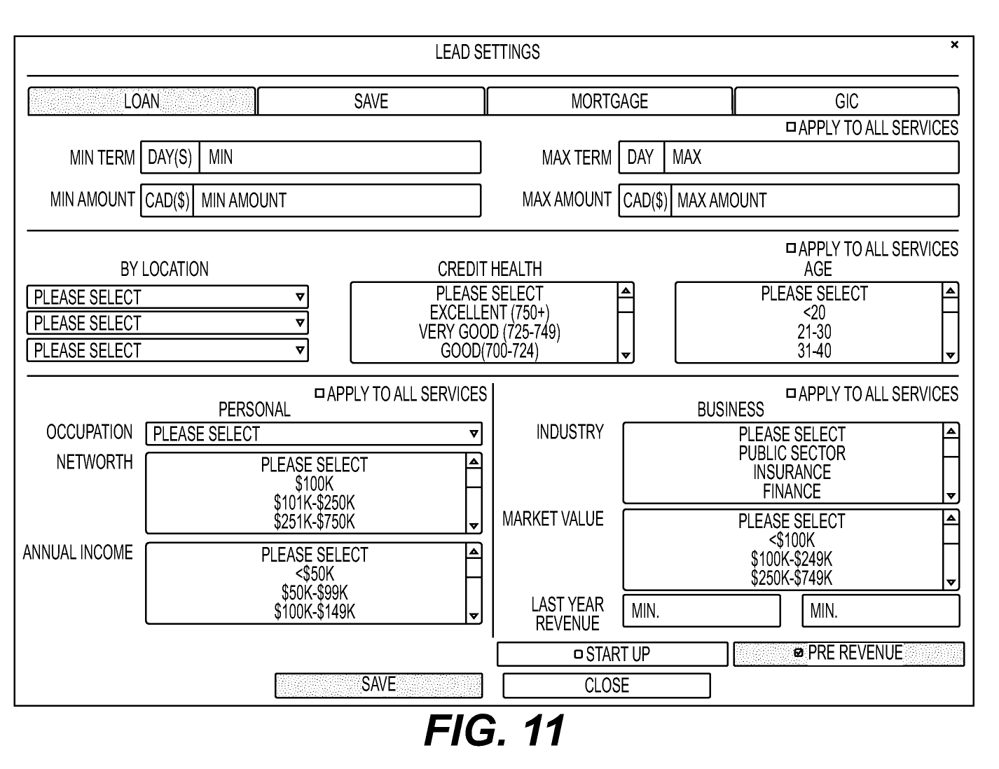

The advertising of the Demanders need is controlled by the system and uses the configuration of the target market (also known as ‘lead settings’) that have been set by the Supplier/Provider. The system includes administrator and user defined data about products and services, and matching that data with desired relationships of the opportunities and market needs the specific provider/suppliers wants to compete on and service. Lead settings to configure target markets can be based on any product/service need definition available to Demanders and ranges, selective criteria and automatic by amount in different currencies, terms, age group, credit health, industry, net worth, occupation, and other Demander profile related data. A sample of how a provider configures their target markets to serve each product and service is included below, and in this sample financial products/services is shown FIG. 11.

### Presentation Management

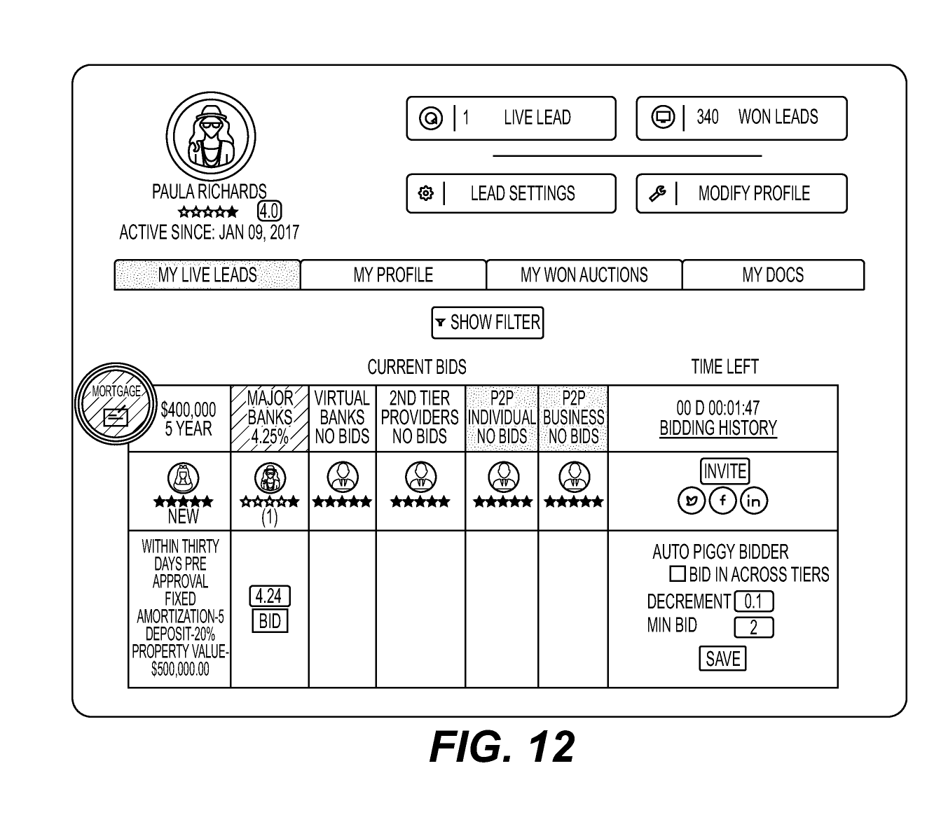

The Open Presentation modules provide the functionality to manage the entities, interfaces, processes, communications and reporting of the open competition process which is mainly controlled by the provider/supplier actions once the opportunity has been presented to them. As illustrated in FIG. 1, at 104, the providers and suppliers review the opportunity the system presented, using system provided risk management tools and/or data as well as external processes that leverage proprietary risk data analysis models, and submit offers through system interfaces for the Demander or buyer to preview. This step can be iterative until the provider or supplier is satisfied with their submitted offer for the business development opportunity presented, or the system configured logic can close the opportunity to prevent additional offer submissions. A sample of the provider/supplier dashboard and the presentation of the opportunity as a call-to-action for the provider/supplier to submit an offer is shown in FIG. 12.

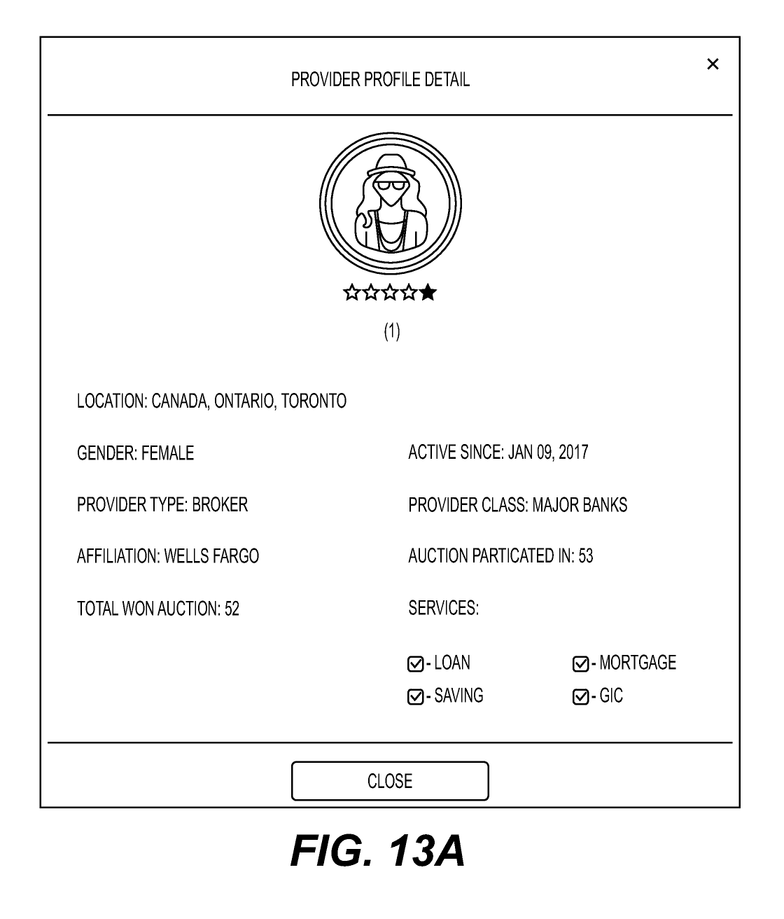

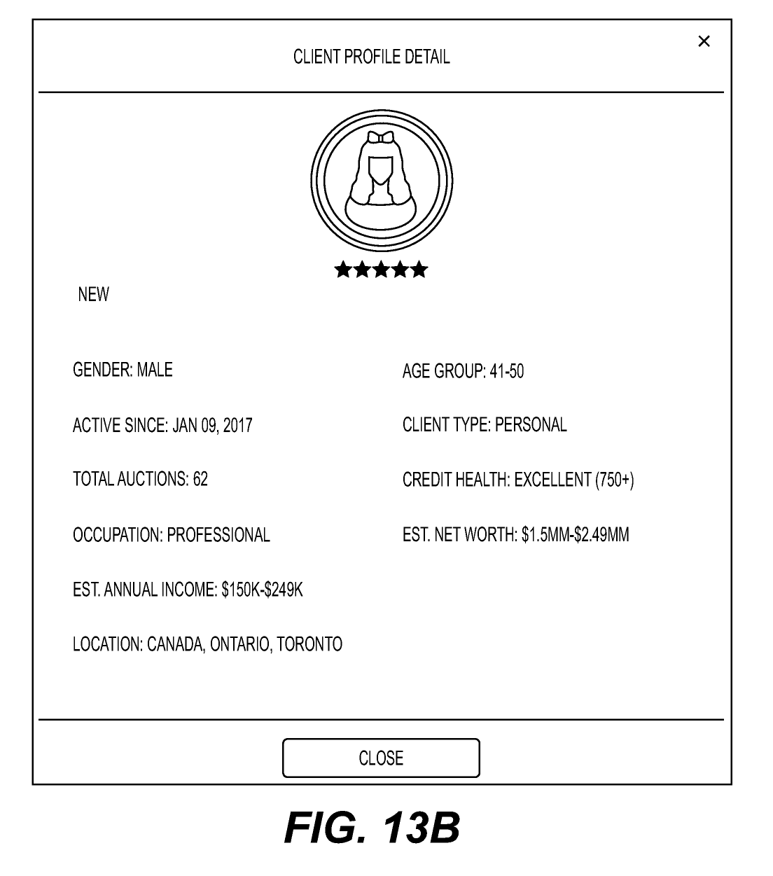

A compilation of selected Demander profile data and opportunity information is presented to allow the provider/supplier to apply rational decision making, adjudicate and assess the risk associated in servicing the Demander defined opportunity. Data and information related to the Demander and provider/Demander is also resourced, pulled and presented through the systems' native database and external systems such as social media platforms, regulated registers and other industry specific performance indicators stored on external platforms, to enrich the overall matching process between Demander needs and solution providers. Example user interfaces are shown in FIGS. 13A-13B.

Trend, economic, expert and native market data and information from internal and external sources is also included in the Presentation Management Views to provide insight and nurture leads on the specific opportunity product/service market positioning, popular costs and returns, and other qualitative competitive statistics. This form of market data and information is used throughout the system, before, during and after the opportunity's open competition and is used to educate Demanders, providers/suppliers and administrators to gain confidence in the matching of Demander needs with solution providers process, resulting in more efficiency in the Demander shopping and provider/supplier sales cycles.

To further enrich the matching of Demander needs with solution provider's process, the system indicates Demander and provider/service behavior and emotions using virtual identifiers such as avatars, and displaying historic and current activity data at the profile level and at the opportunity level. At the opportunity level, the system will show viewability and activity data such as # of times opportunity viewed, total # of participating providers/suppliers, # of top active providers etc. An indication of the provider/suppliers offer submitting aggression is also provided by displaying a ratio of total number of offers made by an individual provider/supplier to total number of offers made by all the provider/suppliers in the open competition provider/supplier pool for the specific opportunity available.

Indicating a provider/suppliers and/or Demander's demand economic advantage over other provider/suppliers and/or Demanders, is a key driver for data and information displayed in the Offer Presentation sub system. In a traditional closed bidding system, providers/suppliers are unaware of their competitors and their offers to the Demander and have no opportunity available to make a counter offer. In this open offer presentation and competition method, suppliers and providers can monitor their offerings to the potential Demanders and re-quote the product/service at a more competitive rate or price using transparent information affecting the sales cycle of a specific opportunity available.

The system will allow provider/suppliers to submit offers efficiently with the ability to re-submit offers manually or atomically within selective product/service availability channels to the Demander. The system provides an interface to set min/max limits, decrements/increments of offer rates and other values and controls to support an automatic offer resubmission based on values set on opportunity variables.

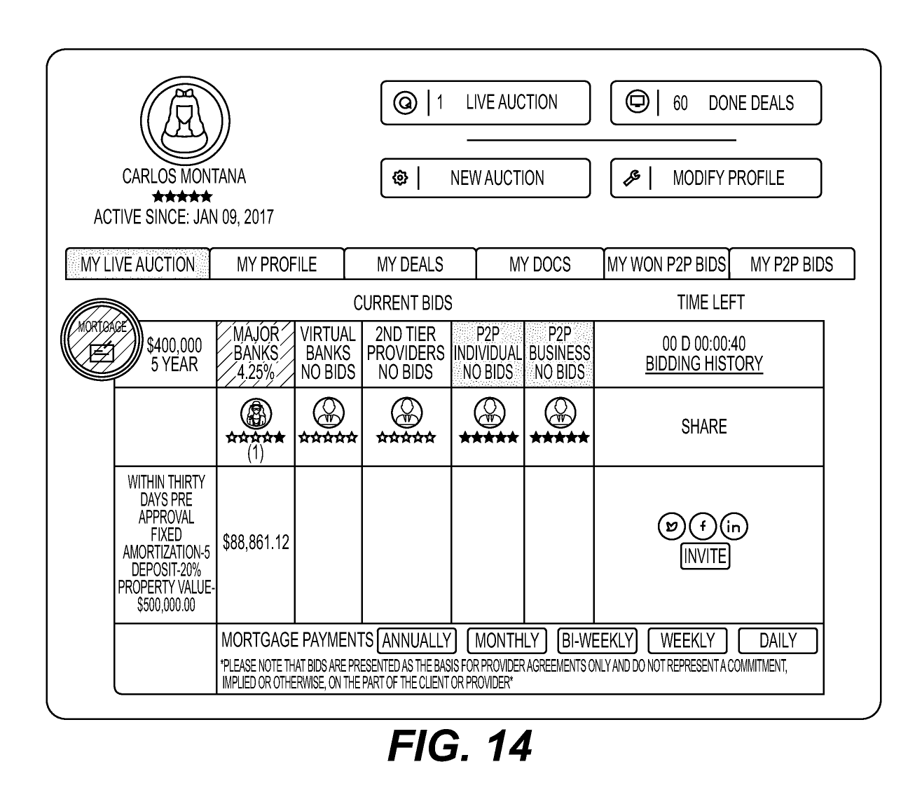

With reference to FIG. 14, the Demander view of the open competition process is optionally hands-off and the system will present offers and information reflecting an evaluation and performance of those offers as the open competition progresses. The Demander view indicates best offer received within each provider/supplier and show total performance in terms of monies saved or value gained from with the first bid to the last best offer.

The system provides a timing element that will apply to the open competition and offer presentation process. Those timing constraints are essentially to ensure the efficiency of the competition process and are configurable by the Demander and/or provider/supplier or the marketplace administration of the system. Configurations of the timing can be applied t with user groups and can be different for different product/service types.

### Value Management

The system determines a relationship has been establish with the winning provider/supplier offers and the Demander's opportunity once the open competition presentation has closed and/or through and user matching features independent of the competition process. The Value Management modules provide the relationship and overall value functionality to manage the interface, process, communications and reporting of the potential relationship data and two-way feedback system that provide aggregated scores to the marketplace community. As illustrated in FIG. 1, at 106, the system will use configured logic and factors to assess all the submitted offers and present the best-results-for-Demander. The system will exchange additional information to both parties and connect the Demander and the providers or supplier. External processes can be utilized to initiate, append or complete the transaction and thereafter Demanders and providers or suppliers are expected to return to the system at single or multiple stages to organize the deal and provider ratings and feedback for each other

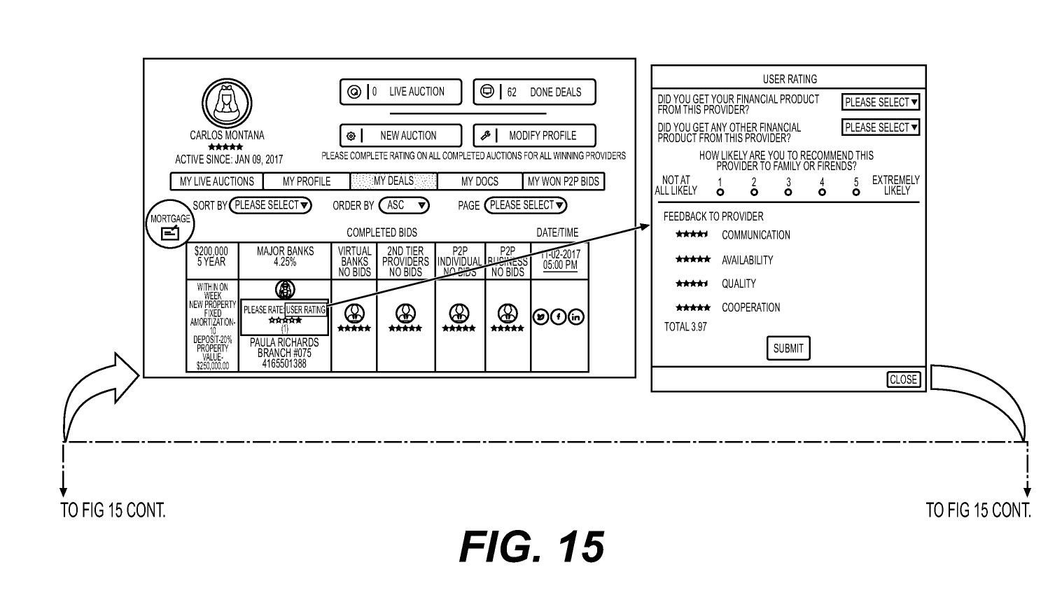

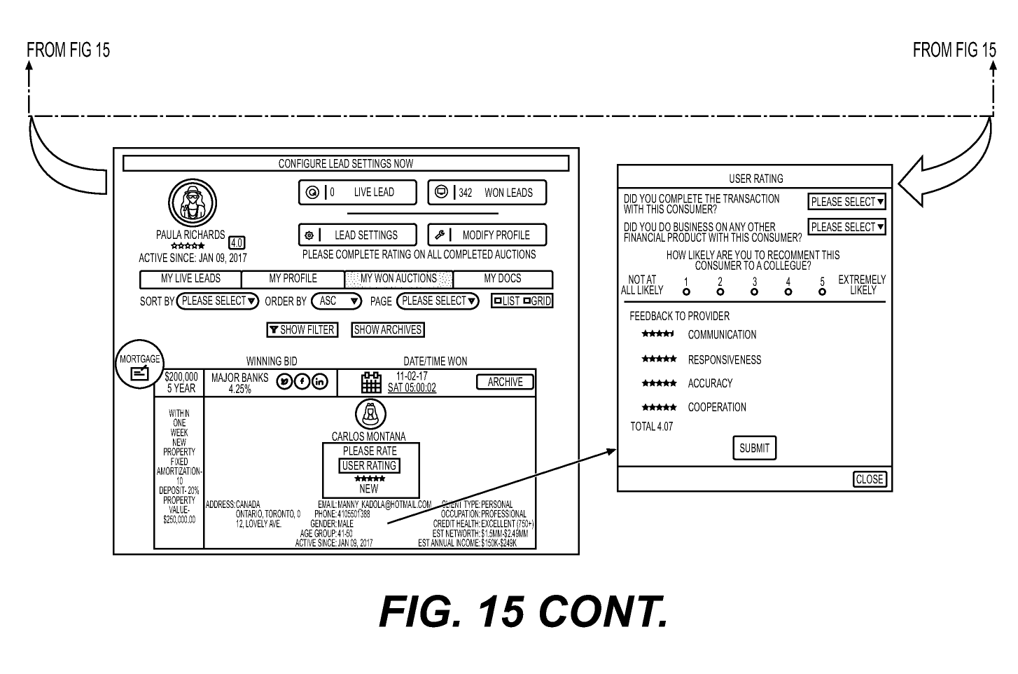

The system further develops the Demander and provider/supplier relationship by providing a value management structure where all party's performance can be managed through a bi-directional review based on the competition experience and/or external experiences amongst the users of the system. The bi-directional ratings and value management data collected in the process is illustrated below where clients will provide feedback for the provider/supplier, and provider/supplier will provide feedback for the Demander, as shown in FIG. 15.

The system has functionality and is configured to provide tiered value delivery to providers/suppliers and can be used to measure the degree of efficiency and effectiveness of the Demander confidence build process and the sales cycle initiated and developed by the system. Provider/suppliers that offer the overall best offer as defined by the system and/or Demander, get higher efficiency rate due to a timed exclusivity to the Demander contact details before the runner-up providers/suppliers, increasing the higher possibility of closing the deal with no interference from competition and having a strong first-contact position. Runner up provider/suppliers in the system gain the same access and tiered efficiency value and may have to work a little harder to close the sale. Demander get immediate access to all winning provider/suppliers in each channel and can boost efficiency by connecting directly with any provider/suppler and any time after the open competition presentations.

The system provides the abilities to Demanders and/or providers/suppliers to upload, share and distribute documentation and other digital media files through the documentation management module and tools available on the system. Hyperlinks and various levels of security can be defined by users and marketplace system administrators. Social media platform integration is provided in the system domain throughout the open competition presentation and value management subsystem to increase the visibility across other online communities, offering backlinks back to the native system and contributing to the build of the reputation of the Demander and provider/supplier through various presentations of actions. Once the system has connected and/or established a relationship amongst the provider/supplier and Demander, the system provides features to pursue a digital completion of the transaction through native and external system such as the providers/suppliers own or approved system further improving the efficiency, and the system provides modules that allow for a network to be configured and self-defined by the Demander and/or the provider/suppliers. This network intelligence data in the system can be used by provider/suppliers to further increase efficiency and effectiveness on future sale cycles, and the Demanders can use the network to invite preferred providers for future opportunities.

### Marketplace Administration and Operations

The System Administration modules provide the functionality to manage products and services, workflows, exceptions, security, role definition, business performance command center dashboards, revenue generation and data types throughout the system. The administrative back office subsystem of the marketplace system can provide real-time visibility into the happenings of the marketplace and allow marketplace administrators to address errors, omissions and miscalculations. Workforce management structures in the system allow for the management of operations queues and workflows by allowing for configured roles and skill sets, view/editable rights of opportunity, open competition presentation, value management process and marketplace profile environment. Product/Services structure are configured for the marketplace through the administrative modules of the system. Product/Services variables and interfaces can be inherited from previous configured product/services and can be tailored to the specific profiles of the Demander and/or provider/supplier. Fee structures are configured through the administrative modules of the system. Fees can be applied on a fixed flat basis or a percentage of opportunity values, and can be tiered for provider/supplier channels, types, and product/service types and channel. The system also features modules to allow procurement of credits or bulk pre-purchases at a discount rate and can provide monetary and/or credit values for referrals of Demanders and/or providers/suppliers. Fee structures are also provided to manage affiliate marketing programs that the system connects with, such as driving traffic that resulted in a signup and/or a completed opportunity open competition presentation for a fee.

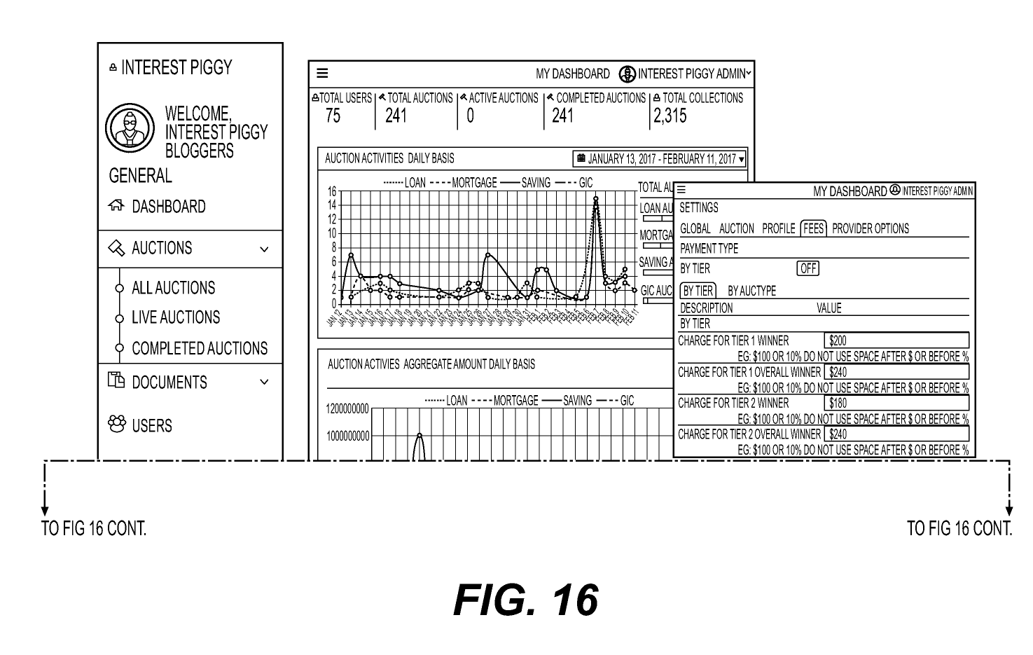

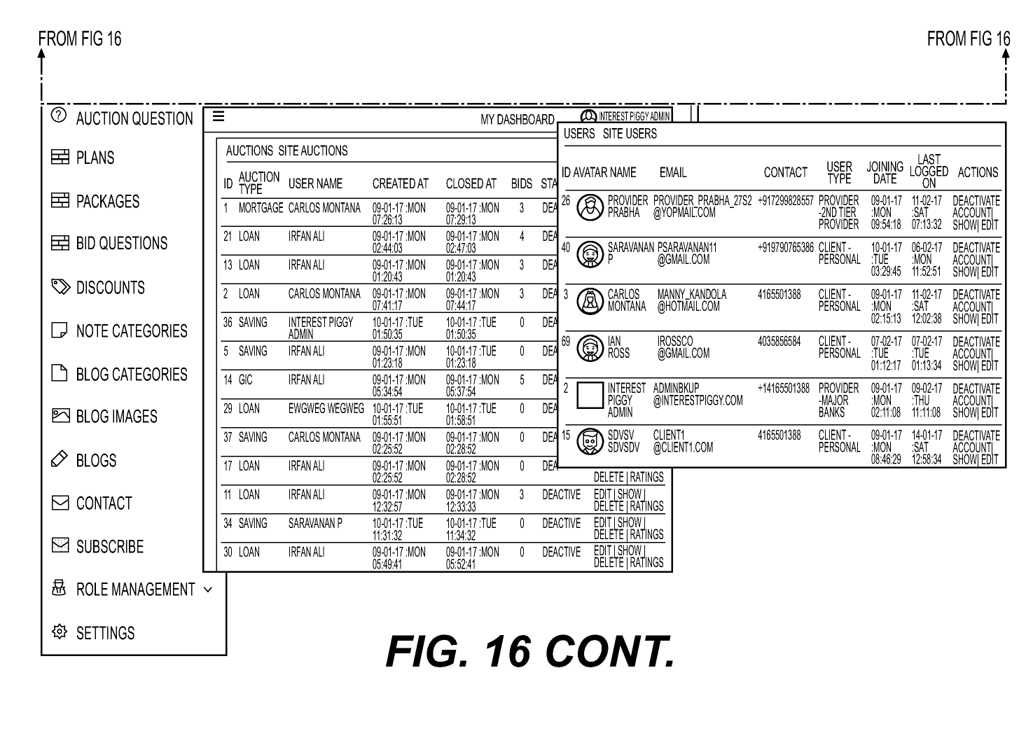

Value management data mining and communication structures and tools are also provided by the system through the marketplace administration and operations modules that allow to further enhance the value and product development of the system and its penetration of the market it serves. Administrators are also provided with positing ability of blogs and news to viewers/subscribers to provide expert panel and marketplace communication on a selective audiences and/or at public level. In addition, the system provides data consumption tools in an effort to optimize the marketplace business. The system will allow the marketplace manager to base optimization planning by using activity analysis data intelligence tools. The Traffic Management modules provide the functionality to data mine the activity data that will be available in the system. These modules provide the engine behind the data dashboards used for internal administration, marketing and planning, as well as deploying data-as-a-service to the Demander and provider network on the system. Examples of the views the system provides to marketplace administrators are show in FIG. 16.

### Public Layers and Integrations Modules

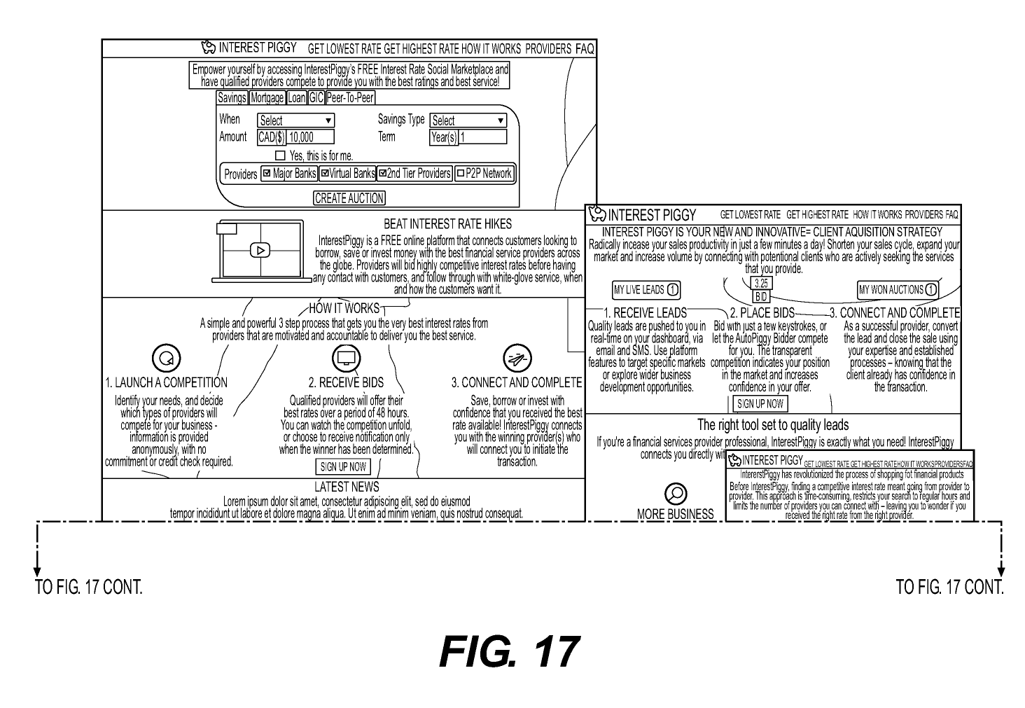

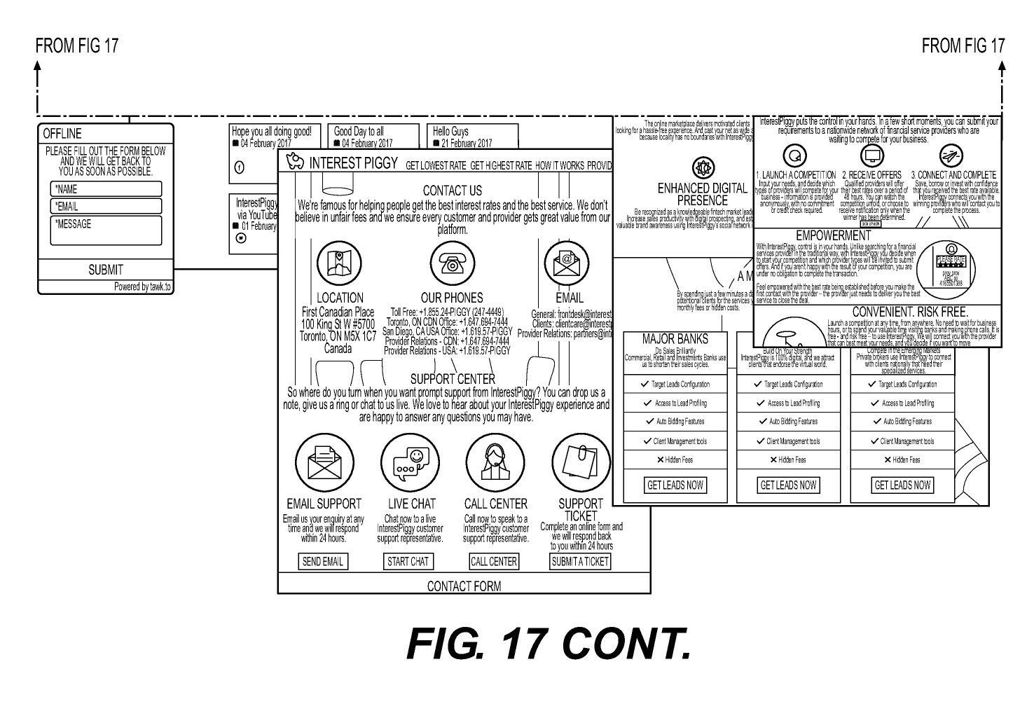

The system will be enclosed within a public website that will be used as an inbound marketing tool for the business. The Public Interaction modules provides the functionality to construct the public facing views and presentation layer of the system. These modules include an Application Programming Interface (API) for supporting the authentication and authorization model, includes a digital content editing platform and publication across the site and the contact-center interface such as online chat and contact form requests. These modules integrate views and controllers from other systems and defines multiple colors and style used throughout native system and maintains consistency through leveraging cascading-style-sheets (CSS) and JavaScript web programming technology. Examples of the public layers of the system are shown in FIG. 17.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device.

One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for implementing an open competition of a Demander's set of requirements for products/services, comprising:
receiving definitions from the Demanders that are directed to a specific business opportunity;
matching the business opportunity with a provider's configured target market;
receiving, from providers matched with the business opportunity, a better-offer-than-last offer in a home tier to determine a winning provider, wherein all offers are visible to all providers, and wherein Demander's identity information is masked and only selective performance based information is available to the providers; and
sharing Demander information with the winning provider.

2. The method of claim 1, further comprising presenting relationship management modules offering two-way accountability and an opportunity to establish a preferred network between the users of the system.

3. The method of claim 1, further comprising:
presenting a first user interface on a device associated with a Demander that receives the definitions;
receiving profile and preference information associated with the Demander; and
storing the profile and preference information.

4. The method of claim 3, further comprising:
processing the profile information to perform the matching of the business opportunity with the provider's configured target market and/or the demanders preferences.

5. The method of claim 3, further comprising displaying a second user interface to manage the profile and preference information.

6. A system, comprising:
authentication and authorization modules that receive registration and identification information from a user;
opportunity management modules that nurture, construct, match and present an opportunity defined by the user with a configuration associated with providers target markets;
presentation modules that manage entities within the system and report a status of matching being performed by the opportunity management modules; and
value management modules that establish a relationship between the users of the system.

7. The system of claim 6, further comprising models that maintain data and relationships within a database.

8. The system of claim 7, further comprising controllers that define all possible scenarios and interactions within the system by querying the models for specific data that is organized into a format associated with a specified view.

9. The system of claim 7, further comprising views that provide presentation layer views of data.

10. The system of claim 6, wherein the authentication and authorization modules further receive profile and payment information associated with the user.

11. The system of claim 10, further comprising processing the profile information to determine predetermined ones of the providers who best align with the opportunity.

12. The system of claim 11, wherein the opportunity management modules visually presents the opportunity to the providers.

13. The system of claim 6, further comprising providing a user interface in which a provider configures their respective target markets, rates and other products and services settings.

14. The system of claim 6, wherein the presentation modules include market and risk data analysis models used by the providers to review the opportunity.

15. The system of claim 6, further comprising:
providing a compilation of user profile data and opportunity information to allow the provider; and
providing external information to the provider to enhance matching.

16. The system of claim 15, wherein the external information is social media information.

17. The system of claim 15, wherein the external information is one of trend, economic and market data.

18. The system of claim 6, wherein the value management modules present a best-results for the user based on availability of the providers target markets.

19. The system of claim 6, wherein the value management modules provide bi-direction feedback between the users of the system, with or without a competition being created.

20. The system of claim 6, wherein an electronic transaction completion mechanism is provided to the users of the system.
